(19) United States
(12) Patent Application Publication
(10) Pub. No.: US 2013/0179288 A1
(43) Pub. Date: Jul. 11, 2013

(54) COLLECTING AND USING ANTHROPOMETRIC MEASUREMENTS

(71) Applicants: Asaf Moses, Berlin (DE); Naomi Keren, Givat Shmuel (IL); Mor Amitai, Tel-Aviv (IL)

(72) Inventors: Asaf Moses, Berlin (DE); Naomi Keren, Givat Shmuel (IL); Mor Amitai, Tel-Aviv (IL)

(73) Assignee: UPcload GmbH, Berlin (DE)

(21) Appl. No.: 13/825,362

(22) PCT Filed: Nov. 17, 2011
(86) PCT No.: PCT/IL11/50017

§ 371 Date: Mar. 21, 2013

Related U.S. Application Data
(60) Provisional application No. 61/553,228, filed on Oct. 30, 2011.
(60) Provisional application No. 61/414,513, filed on Nov. 17, 2010.

(51) Int. Cl. G01B 11/02

(52) U.S. Cl. CPC G01B 11/022
USPC 705/26.1; 348/135

(57) ABSTRACT

A computer program for obtaining anthropometric measurements of a person, implementing a method including providing instructions to a person to set up conditions for producing a suitable image, receiving the image from a camera, the image including at least part of the person's body, analyzing the image, providing at least one measurement based, at least in part, on the analyzing. Related apparatus and methods are also described.

### RELATED APPLICATIONS

This application claims the benefit of priority of U.S. Provisional Patent Application No. 61/553,228 filed Oct. 30, 2011, titled “Collecting and using anthropometric measurements”, and of U.S. Provisional Patent Application No. 61/414,513 filed Nov. 17, 2010, titled “Method and apparatus to an application that automatically measures lengths, circumferences, volumes and contours of objects in data output that is received from an image capturing device”, the contents of which are incorporated herein by reference in their entirety.

### FIELD AND BACKGROUND OF THE INVENTION

The present invention, in some embodiments thereof, relates to a method and a system for generating anthropometric measurements, to a method and a system for using the anthropometric measurements, and, more particularly, but not exclusively to using cameras to capture images for analysis and computation of the anthropometric measurements, and yet more particularly, but not exclusively, to clothes fitting and shopping.

The present invention, in some embodiments thereof, relates to communication, ecommerce, clothing, and more particularly to measuring an item or person, which is posed in front of an image capturing device.

Additional background art includes:
G. Friedland, K. Jantz, R. Rojas: SIOX: Simple Interactive Object Extraction in Still Images, Proceedings of the IEEE International Symposium on Multimedia (ISM2005), pp. 253-259, Irvine (California), December, 2005;
G. Friedland, K. Jantz, T. Lenz, F. Wiesel, R. Rojas: Object Cut and Paste in Images and Videos, International Journal of Semantic Computing Vol 1, No 2, pp. 221-247, World Scientific, USA, June 2007;
Livewire (MORTENSEN, E. N.; BARRETT, W. A. Intelligent scissors for image composition. In: SIGGRAPH '95: Proceedings of the 22nd annual conference on Computer graphics and interactive techniques. New York, N.Y., USA: ACM Press, 1995. p. 191-198;
Richard J. Radke, Srinivas Andra, Omar Al-Kofahi, and Badrinath Roysam: Image Change Detection Algorithms: a systematic Survey, IEEE TRANSACTIONS ON IMAGE PROCESSING, VOL. 14, NO. 3, MARCH 2005;
J. M. Park and Y. Lu (2008) “Edge detection in grayscale, color, and range images”, in B. W. Wah (editor) Encyclopedia of Computer Science and Engineering, doi 10.1002/9780470050118.ecse603;
W.-Y. Wu and M.-J. J. Wang, Elliptical object detection by using its geometric properties, Patt. Recog., 26-10 (1993), 1449-1500;
Kanatani, K., Ohta, N.: Automatic Detection Of Circular Objects By Ellipse Growing. Int. J. Image Graphics (2004) 35-50;
Duda, R. O. and P. E. Hart, “Use of the Hough Transformation to Detect Lines and Curves in Pictures,” Comm. ACM, Vol. 15, pp. 11-15 (January, 1972); and
R. Gonzalez and R. Woods Digital Image Processing, Addison-Wesley Publishing Company, 1992, pp 415-416; and
U.S. Published Patent Application No. 2002/0138170 of Onyshkevych et al.

### SUMMARY OF THE INVENTION

The present invention, in some embodiments thereof, relates to using a camera, such as a webcam, to take images of a person, and calculate anthropometric measurements of the person.

The measurements are used in any of a variety of uses.

In some embodiments, the measurements are provided as clothing sizes, guiding the person in selecting clothes.

In some embodiments, a computer for providing the measurements serves as a hub, optionally accessed via a web site, for the person to connect to clothing suppliers, serving as a base for customer to business transactions.

In some embodiments, the computer for providing the measurements also serves as a repository for the person to keep the measurements.

In some embodiments, the measurements are collected, provide statistics to businesses, and serve as a base for business to business transactions.

In some embodiments, the measurements are used to give medical or health related information about the user, to the user or to others.

According to an aspect of some embodiments of the present invention there is provided a computer program for using a first computer to obtain anthropometric measurements of a person, the computer program implementing a method including providing instructions to a person to set up conditions for producing a suitable image, receiving the image from a camera, the image including at least part of the person's body, analyzing the image, providing at least one measurement based, at least in part, on the analyzing.

According to some embodiments of the invention, the at least one measurement is provided in units of clothing size.

According to some embodiments of the invention, further including accepting input from the person, the input including the person's preference for clothing fit.

According to some embodiments of the invention, further including accepting input from the person, the input including a clothing size of an article of clothing which the person knows, and an indication of whether the article fits tight, fits well, or fits loose.

According to some embodiments of the invention, the providing instructions includes providing instructions from the first computer, the receiving and the analyzing include receiving and analyzing by a second computer, and the providing at least one measurement includes providing at the first computer.

According to some embodiments of the invention, the measurements are associated with the person and stored for further use.

According to some embodiments of the invention, the instructions include instructions for the person to hold an object of known dimensions as a dimensional reference in the image.

According to some embodiments of the invention, the object is a CD. According to some embodiments of the invention, the object is a circular optical storage medium. According to some embodiments of the invention, the object is a ball.

According to some embodiments of the invention, the instructions include instructions for the person to stand next to an object with known dimensions, acting as a dimensional reference in the image.

According to some embodiments of the invention, the instructions include instructions for clothes which the person should wear while the camera is taking the image.

According to some embodiments of the invention, the instructions include instructions for positioning the camera.

According to some embodiments of the invention, the instructions include instructions for selecting a background against which the person should be positioned while the camera is taking the image.

According to some embodiments of the invention, the instructions include displaying an image stream taken by the camera, and overlaying guide marks on the image stream in order to assist the person to position the camera and to position the person's body so as to produce an image for the analyzing.

According to some embodiments of the invention, the analyzing includes using an image segmentation method to segment an image of the person's body from a background.

According to some embodiments of the invention, the receiving an image includes receiving a plurality of images.

According to some embodiments of the invention, the receiving an image includes receiving a stream of images.

According to some embodiments of the invention, the providing instructions includes providing instructions to the person to move the camera, and the analyzing includes using an image segmentation method to separate an image of the person from a background against which the person should be positioned while the camera is taking the image, based, at least in part, on analyzing a movement of the person's body relative to the background.

According to some embodiments of the invention, the providing instructions includes providing instructions to the person to move relative to a background against which the person is positioned while the camera is taking the image, and the analyzing includes using an image segmentation method to separate an image of the person from the background, based, at least in part, on analyzing a movement of the person's body relative to the background.

According to some embodiments of the invention, the providing instructions to set up conditions, the receiving an image from the camera, and the analyzing the image, are repeated, and a plurality of measurements is provided.

According to some embodiments of the invention, the providing instructions to set up conditions, the receiving an image from the camera, and the analyzing the image, are repeated, and the at least one measurement is based, at least in part, on the analyzing of a plurality of images.

According to some embodiments of the invention, further including storing the at least one measurement in a user profile associated with the person.

According to some embodiments of the invention, further including providing the at least one measurement to an on-line store.

According to an aspect of some embodiments of the present invention there is provided a computer on which the above-mentioned computer program is stored.

According to an aspect of some embodiments of the present invention there is provided a digital medium on which the above-mentioned computer program is stored.

According to an aspect of some embodiments of the present invention there is provided a computerized system for managing a person's anthropometric measurements including a user interface unit for providing instructions to a person to set up conditions for producing a suitable image and for accepting input from the person, a camera for sending the person's image to the system, and a computation unit for computing the person's anthropometric measurements based, at least in part, on the image.

According to some embodiments of the invention, further including a database for storing the person's profile including at least one of the person's anthropometric measurements.

According to some embodiments of the invention, further including a communication unit for sending at least one of the person's anthropometric measurements to an on-line store.

According to an aspect of some embodiments of the present invention there is provided a method of providing a service of managing a person's anthropometric measurement including computing a person's anthropometric measurements from images of the person, and keeping the measurements for use in web shopping.

According to some embodiments of the invention, the service is provided by a browser-based program. According to some embodiments of the invention, the program is configured to be embeddable in a frame including a portion of a web page. According to some embodiments of the invention, the keeping is performed by a cookie on the person's computer.

According to an aspect of some embodiments of the present invention there is provided a method for obtaining anthropometric measurements of a person, using a computer and a camera, the method including (a) the computer providing instructions to a person to pose in a specific pose for a camera to capture the person's image in the pose, (b) the camera capturing an image of the person in the pose, repeating (a) and (b), thereby instructing the person to pose in a set of poses, and capturing a set of images, (c) analyzing the set of images, and (d) providing anthropometric measurements based, at least in part, on the analyzing.

According to some embodiments of the invention, the person is asked to provide personal, bode-related information, and the set of poses is selected based on the information.

According to some embodiments of the invention, further including analyzing an image following the capturing of at least one image, and selecting additional poses based on analyzing the at least one image.

According to some embodiments of the invention, the analysis detects a fat person, and the additional poses are selected from poses considered especially useful for measuring fat persons.

According to some embodiments of the invention, the analysis detects a slim person, and the additional poses are selected from poses considered especially useful for measuring slim persons.

According to some embodiments of the invention, the analysis detects a missing measurement, and the additional poses are selected from poses considered especially useful for analyzing the missing measurement.

According to some embodiments of the invention, the analysis does not identify a key body location, and the additional poses are selected from poses considered especially useful for identifying the key body location.

According to some embodiments of the invention, further including if an anthropometric measurement cannot be computed based on analyzing the set of images, then instructing the person to pose in at least one additional pose selected to enable computing the measurement.

According to some embodiments of the invention, the personal information includes gender. According to some embodiments of the invention, the personal information includes body type. According to some embodiments of the invention, the personal information includes selecting a value from the group short, average, tall, extra tall, and extra short. According to some embodiments of the invention, the personal information includes selecting a value from the group slim, average, fat, extra fat.

According to some embodiments of the invention, at least one pose is a pose in which the person stands facing the camera, with arms away from the body, and the anthropometric measurements include an arm length expressed in terms of sleeve length.

According to some embodiments of the invention, if a sleeve length measurement cannot be computed based on analyzing the set of images, then instructing the person to pose in at least one additional pose in which the person stands facing the camera, with arms further away from the body than in an already captured pose.

According to some embodiments of the invention, at least one pose is a pose in which the person stands facing the camera, with feet apart, and the anthropometric measurements include a trouser length expressed in terms of inseam length.

According to some embodiments of the invention, if an inseam length measurement cannot be computed based on analyzing the set of images, then instructing the person to pose in at least one additional pose in which the person stands facing the camera, with feet further apart than in an already captured pose.

According to some embodiments of the invention, at least one pose is a pose in which the person stands facing the camera, and at least one pose is a pose in which the person stands with a profile toward the camera, and the anthropometric measurements include a waist circumference.

According to some embodiments of the invention, at least one pose is a pose in which the person stands facing the camera, and at least one pose is a pose in which the person stands with a profile toward the camera, and the anthropometric measurements include a neck circumference.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings and images. With specific reference now to the drawings and/or images in detail, it is stressed that the particulars shown are by way of example and for purposes of illustrative discussion of embodiments of the invention. In this regard, the description taken with the drawings and/or images makes apparent to those skilled in the art how embodiments of the invention may be practiced.

In the drawings:

FIG. 1 is an image of an example embodiment of the invention during use;

FIGS. 2A-2F are a first set of example images taken during use of the example embodiment of FIG. 1;

FIGS. 2G-2J are a second set of example images taken during use of the example embodiment of FIG. 1;

FIG. 2K is a simplified flow chart illustration of an example embodiment of the invention;

FIGS. 3A-3B are example images of a screen displaying some positioning guides to a user of the example embodiment of FIG. 1;

FIG. 4 is a simplified flow chart illustration of an example embodiment of the invention;

FIG. 5 is a simplified flow chart illustration of an example embodiment of the invention;

FIG. 6 is a simplified flow chart illustration of an example embodiment of the invention;

FIG. 7 is a simplified block diagram illustration of an example embodiment of the invention;

FIG. 8A is a simplified illustration of a web page of a first company having an embedded frame of a second company providing measurements according to an example embodiment of the invention; and

FIGS. 8B-8H are simplified illustrations of various frames referencing sizing information and clothing information according to an example embodiment of the invention.

### DESCRIPTION OF SPECIFIC EMBODIMENTS OF THE INVENTION

The present invention, in some embodiments thereof, relates to a method and a system for measuring anthropometric measurements, to a method and a system for using the anthropometric measurements, and, more particularly, but not exclusively to using cameras attached to or built into personal devices such as personal computers or mobile devices to provide images used in the measuring.

The term “anthropometric measurement” in all its grammatical forms is used throughout the present specification and claims interchangeably with the term “measurement” and its corresponding grammatical forms, to mean measurements of a person's body. Non-limiting examples of such measurements include: head circumference, neck circumference, waist circumference, thigh circumference, arm circumference, chest circumference, arm length, thigh length, leg length, foot length, hand circumference, crotch height, and so on.

In some embodiments of the invention, an image or several images are taken of a person. Based on the image, the person's measurements are computed. Based on the measurements, a clothing size is suggested.

In some embodiments of the invention, a set of poses is requested of the person, and a set of images of the poses is taken.

In some embodiments of the invention, a specific set of poses is used, optionally a set of poses which works well with a majority of users.

In some embodiments of the invention, a set of poses is crafted for a specific user, either based on input from the user describing his/her body, and/or based on taking one or more images and then iteratively suggesting more poses for more images.

In some embodiments of the invention, the poses are selected for extracting specific measurements—for example a pose with legs spread apart for identifying crotch height and providing a trouser inseam measurement; or a pose with arms held sideways, to identify armpit-to-hand distance and provide a sleeve length measurement.

In some embodiments of the invention, image analysis is used to identify key body locations which are important to the anthropometric measurements. Non-limiting examples of such image analysis include detecting a crotch as a top of an inter-thigh separation; detecting an armpit as a top of an arm-body separation; detecting a neck as a narrow body portion on top of a broad body portion which is the shoulders; and so on.

In some embodiments of the invention, a program which performs the image capture sends the image or images to a remote computer for computing the measurements, and the clothing size is sent back to a computer interacting with the person.

In some embodiments of the invention, the remote computer collects the measurements, and saves the measurements associated with a user profile.

In some embodiments of the invention, the saved measurements provide a cloud-based service for the person, keeping the person's measurements available over the Internet.

In some embodiments of the invention, the saved measurements provide a basis for a consumer-to-business application, with the measurements being provided to an on-line store when the person arrives at the on-line store via a link from a server providing the service of saving the measurements, and/or based on a cookie stored in the person's computer.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

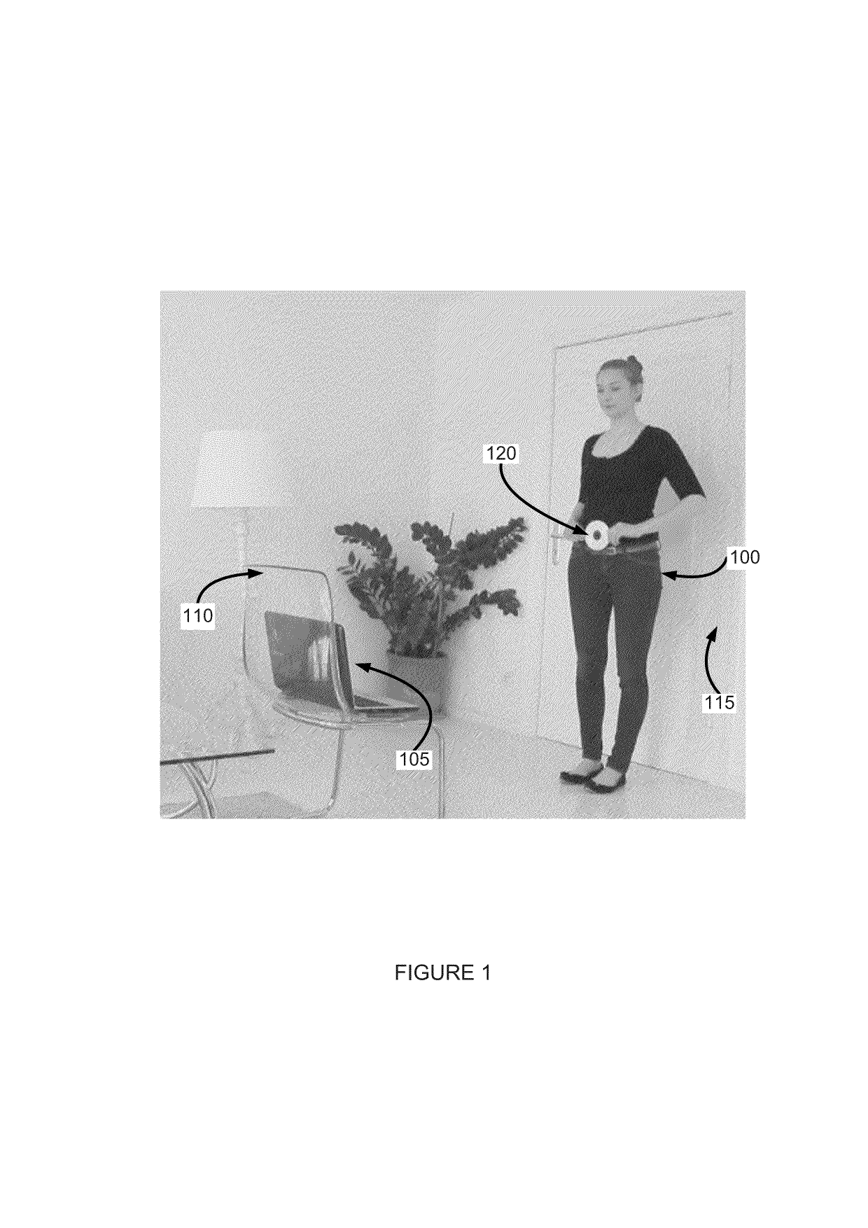

Reference is now made to FIG. 1, which is an image of an example embodiment of the invention during use.

FIG. 1 depicts a person 100 standing in front of a laptop 105. The person 100 placed the laptop 105 on a chair 110, pointing toward a background 115, at a distance of about 10 feet. The laptop 105 runs a program which directs the person 100 to stand close to the background 115, and displays an image, taken by a webcam included in the laptop 105, of the person 100 on the laptop screen. FIG. 1 depicts the background 115 as a light-colored wall and door.

When the person 100 stands such that the webcam captures a good image of the person 100, the laptop 105 captures an image of the person 100, and sends the image, optionally over a wireless network and via the Internet, to a remote computer for computing anthropometric measurements.

The anthropometric measurements are optionally translated to clothing sizes, and provided back to the person using the embodiment of the invention.

It is noted that FIG. 1 depicts the person 100 in a home environment. It is noted that operation of embodiments of the invention are not limited to a home, and that embodiments of the invention may be used at home, in an office, at a workplace, in a store, in malls, outside, in a fitting room in a store, may be provided by a booth in a mall, and everywhere it is possible to perform the process properly.

Having provided the above simplified description of an embodiment of the invention in use, various embodiments will now be described in more detail.

Computers

In some embodiments of the invention, the same computer performs the user interface, as described above with reference to providing instructions to the person 100 of FIG. 1, as performs the computing of the anthropometric measurements. The computer may be any of the following non-limiting list of computers: laptop, desktop, netbook, tablet and even a smartphone.

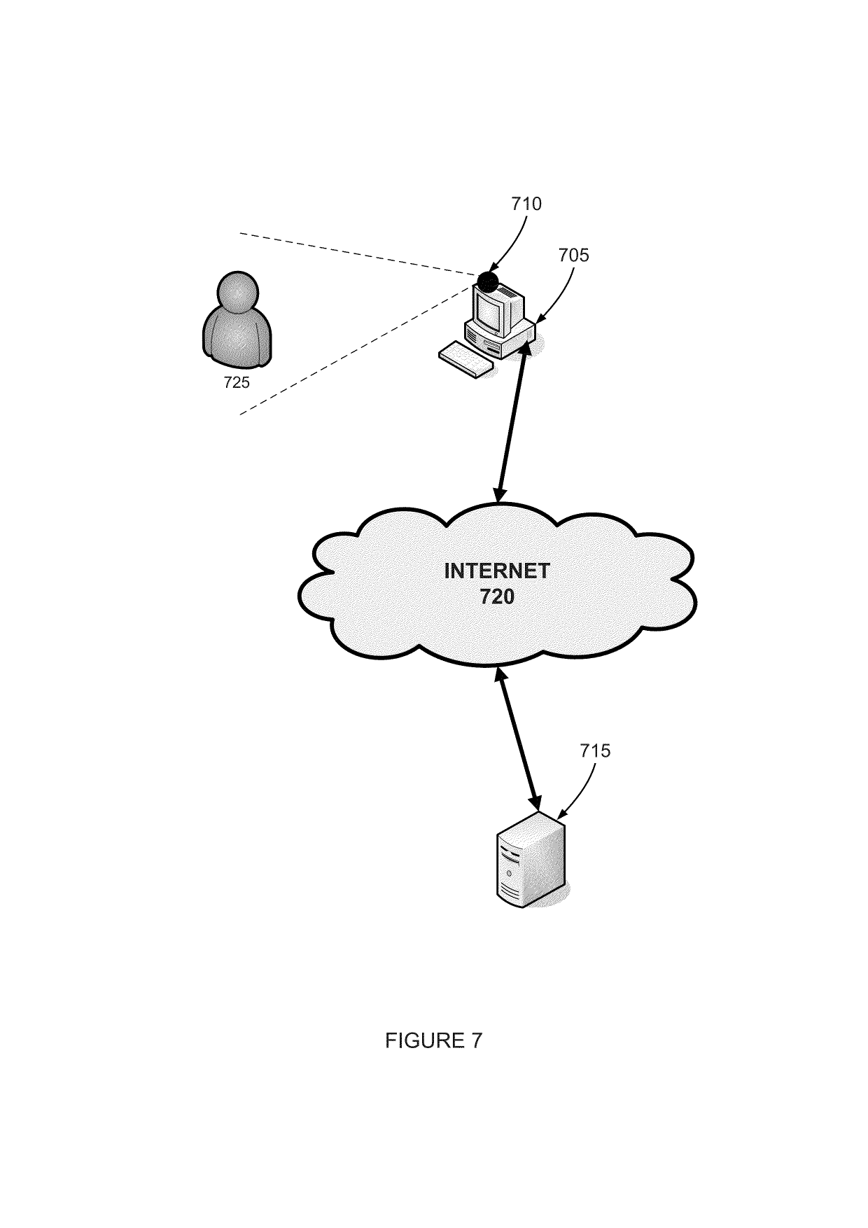

In some embodiments of the invention, providing a user interface and capturing images is performed by one computer, and the captured image and/or images are sent to another computer for computing the anthropometric measurements, as will be further described below with reference to FIG. 7.

Cameras

In some embodiments of the invention, a camera is built into a computer, and serves for capturing an image or images.

In some embodiments of the invention, a webcam is connected to a computer, and serves for capturing an image or images.

In some embodiments if the invention the camera is not connected directly to a computer. The camera sends the images to a computer, and/or saves the images at a location which the computer can access.

In some embodiments of the invention the camera is optionally an infrared camera.

In some embodiments of the invention the camera has a VGA resolution (640×480 pixels) or a resolution of 0.3 megapixels, which is presently typical of webcams and/or front-facing cameras in netbooks, smartphones, and tablets. Higher resolution cameras can provide higher accuracy in measuring the anthropometric measurements.

In some embodiments of the invention, a digital camera sends images to a computer, and serves for capturing an image or images. Digital cameras typically have resolutions much greater than webcams, and can provide greater accuracy of measurement than webcams, and/or optionally perform less repetitions of capturing images and recalculation.

It is noted that in many cases, where capturing or taking or using an image is mentioned herein, a video stream may be used as well. In some embodiments of the invention, images are optionally taken from the image stream and used. In some embodiments of the invention, the image stream or video stream may optionally be analyzed, for example using motion detection to discern a person's body from its background.

In some embodiments of the invention, the camera's physical parameters and optical properties are known, and distortion is optionally calculated from the camera parameters and compensated for.

In some embodiments of the invention, optionally when the camera parameters are wholly or partly unknown, distortion is optionally estimated from the image using one or more of:

a. a distortion calibrator(s)—an appearance of a known reference shape or shapes in the image is optionally used to detect and measure the distortion. The reference object may be a CD, an A3 or A4 paper sheet, a ruler, and so on.

b. a distortion calibrator, such as the reference object, appearing in several images, in different areas of the image.

c. detecting straight lines and analyzing how they are distorted.

d. asking the user/person to move, and see how the person's image appears in different parts of the image.

e. moving the camera.

In some embodiments of the invention a smartphone camera is optionally used, the user holding the smartphone camera in the hand and pointing the camera at him/her self.

It is noted that some smartphones, such as the iPhone 3 and iPhone 4, can be stood on their side on a desk, and in this way perform similarly to a laptop—the camera can view the whole body if the user is distant enough from the smartphone. It is noted that smartphones may be held in position by a device such as a smartphone-compatible tripod.

In some embodiments of the invention a camera, such as a smartphone camera, optionally captures only a portion of a user's body, and separate portions of the body are analyzed from separate images, or only some of the body measurements are calculated.

A Reference Object

FIG. 1 also depicts the person 100 holding a reference object 120. In the example embodiment of FIG. 1 the reference object 120 is a CD.

The reference object 120 is an object of known size. In embodiments where the reference object 120 is used, the reference object 120 provides a segment of an image of known dimensions, providing more accuracy in the computation of the anthropometric measurements.

In some embodiments of the invention, the reference object 120 is a commonly found, or easily obtainable, object of known dimension.

In some embodiments of the invention the reference object 120 is a ball. A reference object having a shape of a ball has an advantage of appearing as a circle in an image, regardless of the orientation of the ball. In some embodiments of the invention the ball is a ball having some standard size, such as, by way of a non-limiting example, a golf ball, a table tennis ball, a tennis ball, and so on.

In some embodiments of the invention the reference object 120 is a disk shaped object. A reference object having a shape of a disk has an advantage of appearing as an ellipse in an image, with a long axis having the same length as the diameter of the disk, regardless of the orientation of the disk. In some embodiments of the invention the disk is a disk having some standard size, such as, by way of a non-limiting example, a CD, a DVD, and so on.

In some embodiments of the invention, markings on the reference object are also used to provide known dimensions. Such markings can be, for example, the central hole in a CD, or markings printed onto a sheet of paper.

In some embodiments of the invention, the reference object is a wall or an upright plane, having reference markings. Some non-limiting examples of such a reference object include a tile wall, with tiles of known size; an upright poster with reference markings; and a wall of a fitting booth with reference markings.

In some embodiments of the invention, more than one reference object is used.

Contrast

In some embodiments of the invention a computer program, such as a program running on the laptop 105, instructs the person to wear clothing of such a color as to produce a sharp contrast with a color of a background against which the person 100 stands.

In some embodiments of the invention a program running on the computer instructs the person to hold a reference object of such a color as to produce a sharp contrast with a color of the person's clothing and/or with the background against which the person 100 stands.

User Interface—Instructions

In some embodiments of the invention a program running on the computer instructs the person to wear tight clothing, so the person's outline in captured images is close to the person's body measurements.

In some embodiments of the invention a program running on the computer instructs the person to stand in certain specific poses so as to capture images suitable for measuring specific anthropometric measurements such as, by way of a non-limiting example, arm width, arm length, thigh width, crotch height, and so on.

In some embodiments of the invention a program running on the computer instructs the person to pull hair away from the neck, so the person's outline in captured images shows the neck not obscured by hair.

In some embodiments of the invention, the instructions are provided as one or more of: on-screen text, an instruction video, and an instruction audio clip.

In some embodiments of the invention, a program running on the computer receives an indication from the person that the person is in a pose, ready for imaging, by using voice input.

Posing for the Camera

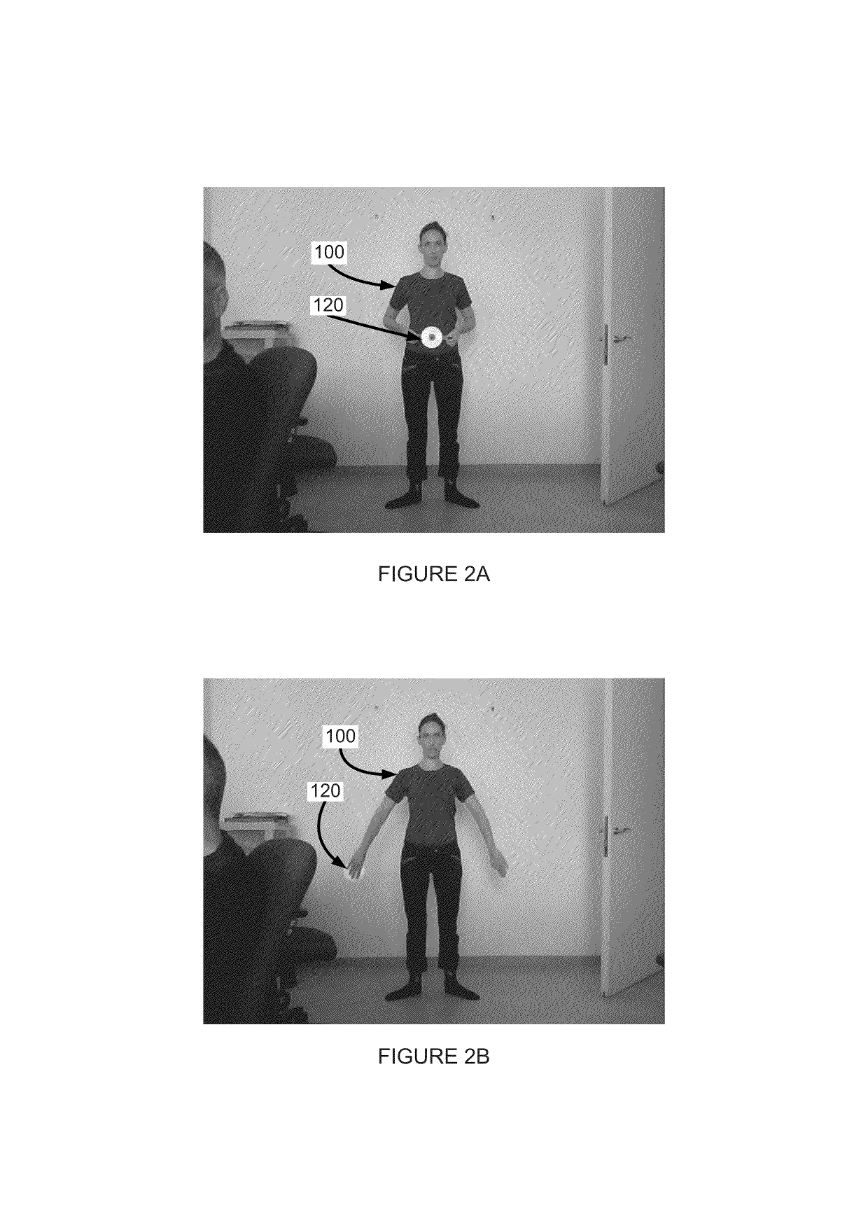

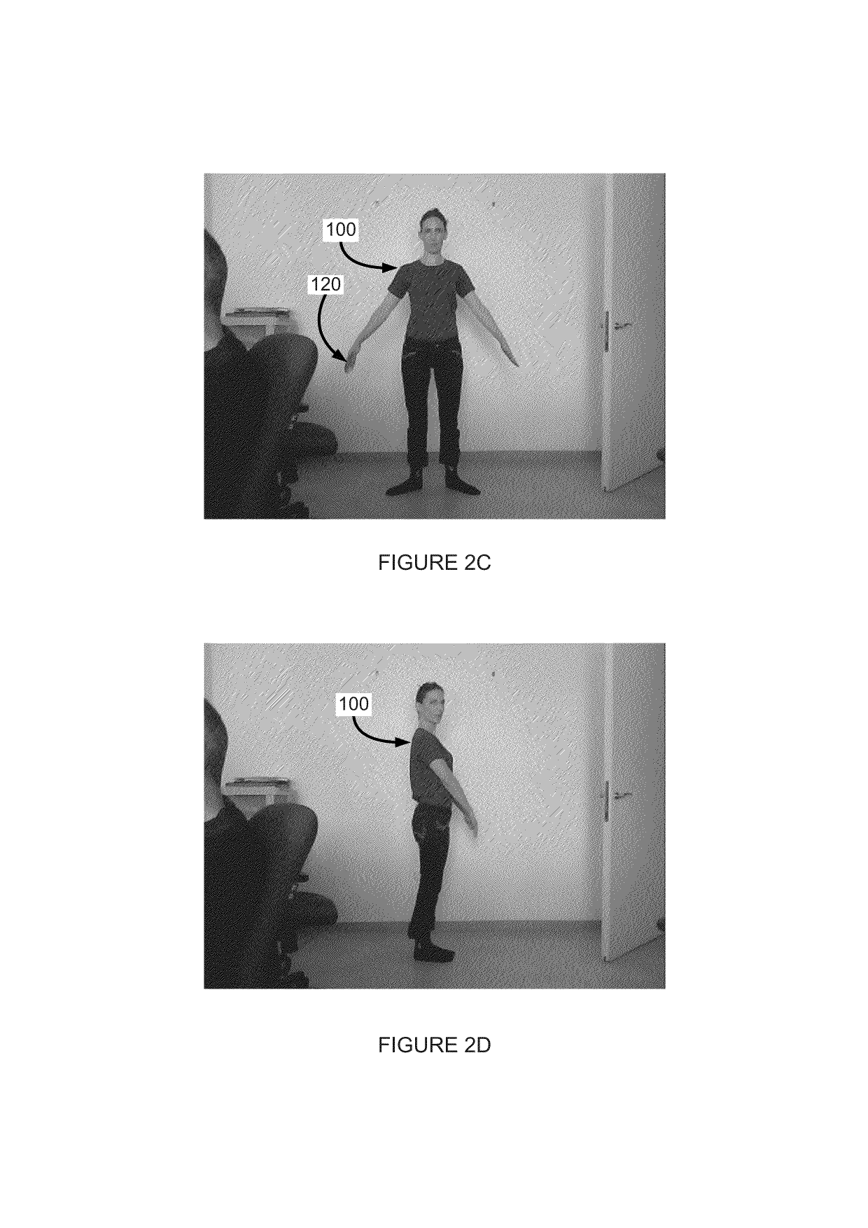

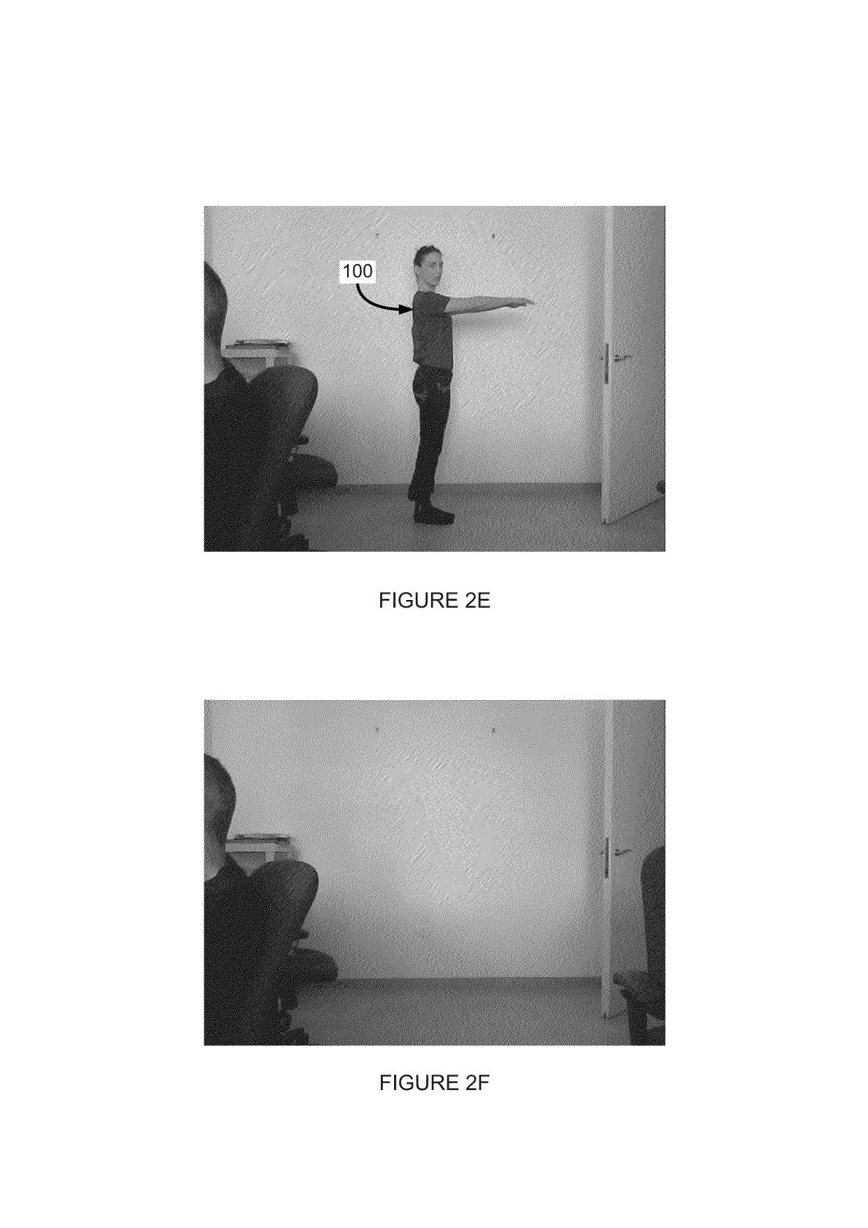

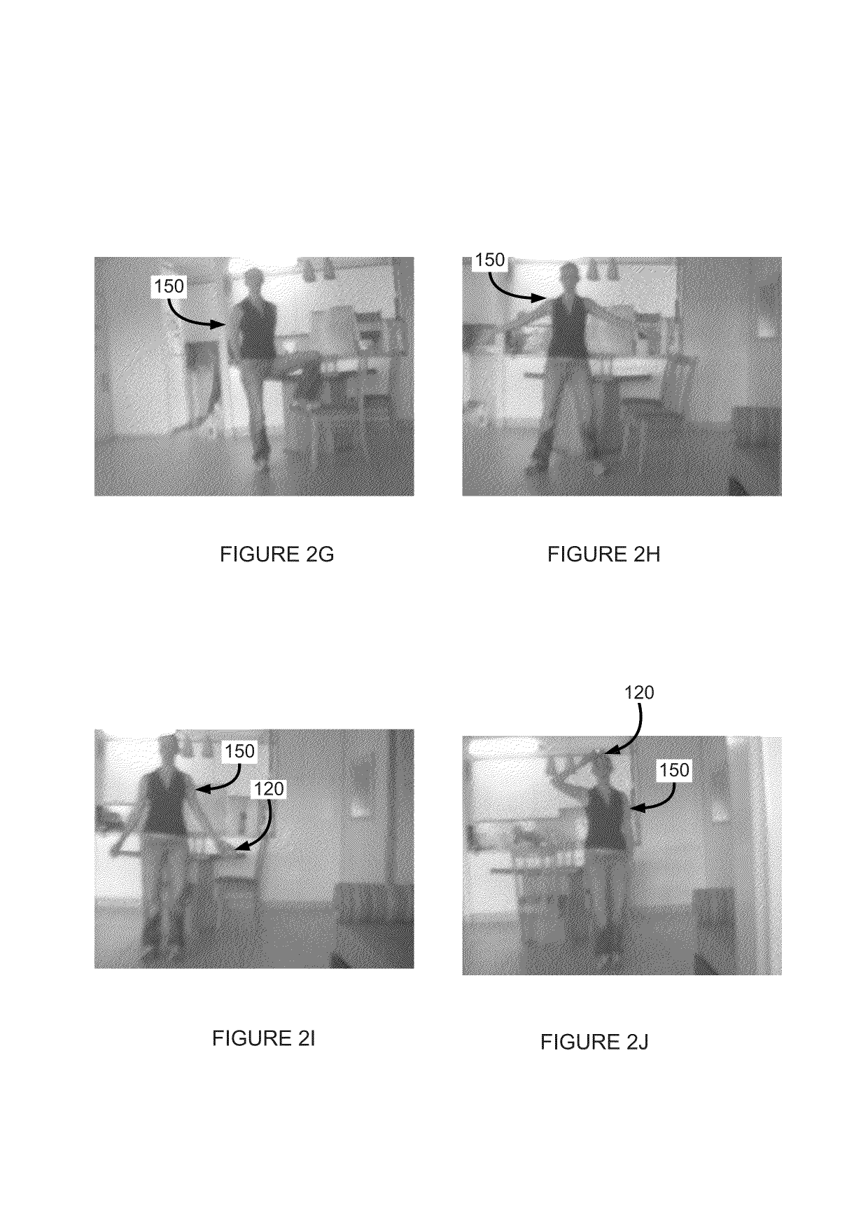

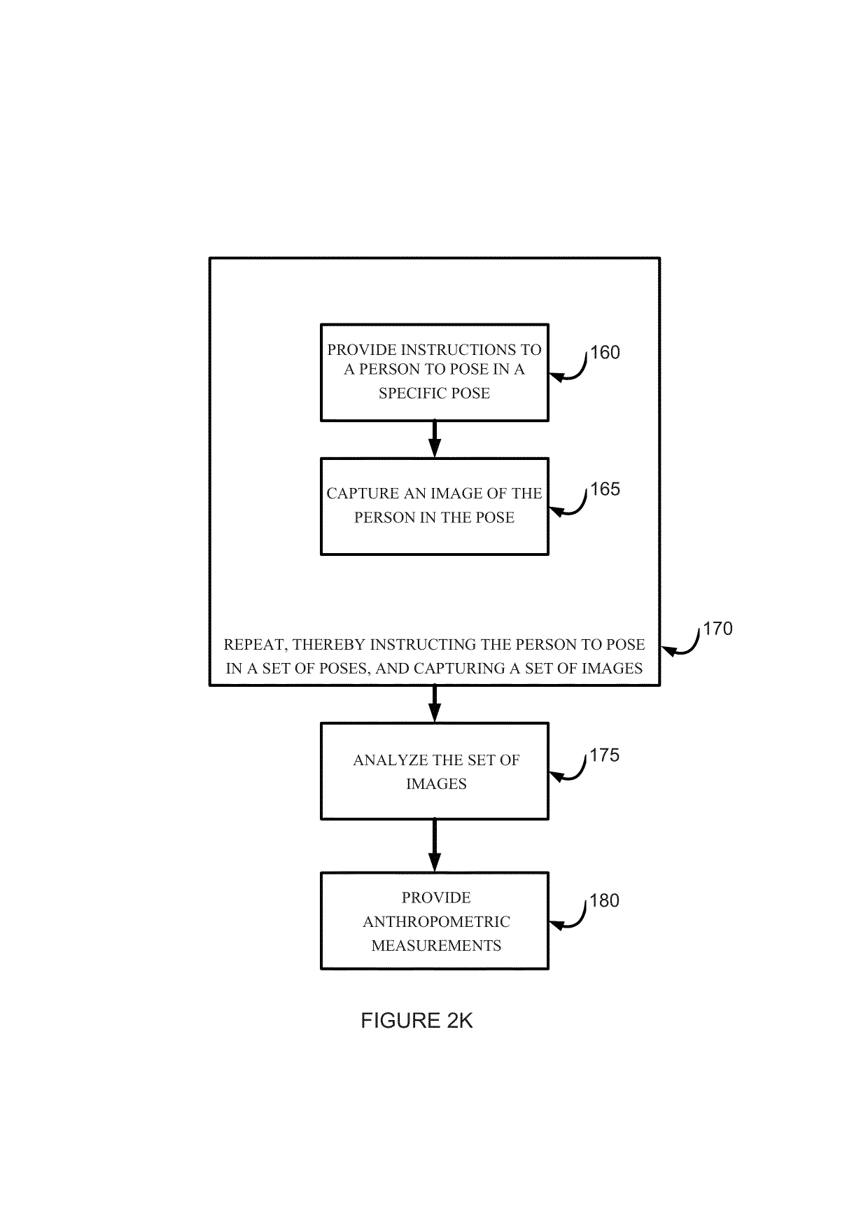

Reference is now made to FIGS. 2A-2F, which are a first set of example images taken during use of the example embodiment of FIG. 1.

FIGS. 2A-2F depicts a person imaged in a set of poses. The poses which the person is requested to pose has a logic to it. In various embodiments of the invention, the poses are selected so as to provide a set of desired measurements. In various embodiments of the invention, the poses may be selected to overcome difficulties in measuring a person, and/or to simplify the process.

A set of poses may include one pose, two poses, three or more poses, up to 6 or 10 poses. A second set of poses may be requested after a first set provides some measurements, or detects potential problems in measurement.

FIG. 2A depicts the person 100 holding the reference object 120, in this case a disk, against her body, enabling a calibration of the imaging system, as well as measurement of some of the person's frontal anthropometric measurements.

In a first pose, depicted in FIG. 2A, a user is requested to stand in front of the image capturing device, so all or part of his/her body is observable by the camera.

The user optionally holds an objector objects that were selected or pre-determined. The manner in which the user should hold the object may optionally vary, and the user may optionally be instructed by a program on how to hold it.

In the first pose the person 100 is standing so her legs are apart from each other, the person's face is facing the camera, and the object which the person 100 holds is a CD. FIG. 2A depicts a CD, but other objects, of known physical dimensions, can be also utilized.

The CD may be held from its side so its circle is presented to the camera.

In some embodiments the CD should be held tight to the user's belly.

It is noted that it is preferable to hold the CD so as to reveal as much as possible of the CD perimeter from the camera.

It is noted that FIG. 2A is especially useful for imaging the reference object, a distance between shoulders, a width of the neck, chest, belly, waist, hips, and inner and outer leg length.

FIG. 2B depicts the person 100 in a pose with her arms away from her body, enabling a measurement of some of the person's frontal anthropometric measurements which were obscured by her arms in FIG. 2A, such as the width of her waist. FIG. 2B has the person 100 holding her hands perpendicular to the line of sight of the camera.

FIG. 2B depicts a second pose, in which the person 100 is optionally requested to stand in front of the camera, with legs to the sides so inner-side of both feet can be clearly seen from the camera perspective. In some embodiments of the invention, the user may optionally be asked to spread his/her arms to the sides so the back of the palm is facing the camera or so that the palm is facing the camera.

It is noted that FIG. 2B is especially useful for imaging a distance between the shoulder, chest, belly waist and hips and neck width, inner and outer leg length, arm length, biceps width, and wrist width.

FIG. 2C depicts the person 100 in a pose with her arms away from her body, similar to the pose of FIG. 2B, but holding her hands parallel to the line of sight of the camera.

FIG. 2C depicts a third pose, in which the user is optionally requested to stand in front of the camera with his/her legs to the sides so inner-side of both feet can be clearly seen from the observer perspective. In some embodiments of the invention, the user may optionally be asked to spread his/her arms to the sides, so his/her palms are facing the camera or alternately the back of the user's palm is facing the camera. The arms are optionally spread to the side so an angle of at least 10 degrees is created between the user's body and arms, when observing the user from the front.

It is noted that FIG. 2C is especially useful for imaging a distance between the shoulder, chest, belly waist and hips and neck width, inner and outer leg length, arm length, biceps width, and wrist depth.

It is noted that the term depth is used for a unit of length, and that depth can optionally be determined by taking an image from a different angle, optionally an image with the person in a pose rotated 90 degrees

FIG. 2D depicts the person 100 in a pose which shows her profile to the camera, and with her arms at a small angle in away from and toward the front of her body.

FIG. 2D depicts a fourth pose, in which the user is optionally requested to present his/her profile, either the left profile or the right profile, so his/her left or right shoulder is facing the camera.

It is noted that FIG. 2D is especially useful for imaging neck, belly, waist, and chest width, and hip depth, arm length, and outer leg length.

FIG. 2E depicts the person 100 in a pose which shows her profile to the camera, and with her arms away from her body and toward the front of her body, approximately parallel to the floor.

FIG. 2E depicts a fifth pose, in which the user is optionally requested to present his/her profile and raise his/her arms. In some embodiments of the invention, the arms are optionally lifted so that when viewing the profile, an angle created between body and arm should be at least 10 degrees.

It is noted that FIG. 2E is especially useful for imaging neck, belly, waist, and chest width, and hip depth, arm length, and outer leg length.

FIG. 2F depicts the scene of FIGS. 2A-2E, without the person 100. An image of the scene of FIG. 2F includes the background without the person 100. In some embodiments of the invention an image of the background without the person 100 is also captured, and helps in segmenting an outline of the person 100 in other images which do include the person 100.

FIG. 2F depicts an option in which the user is optionally requested to exit the camera's field of view. The user is optionally requested to exit the camera's filed of view completely, partly (move to one side) or not at all, i.e. not be requested to leave.

In some embodiments of the invention, the above-mentioned first set of poses may be used in its entirety.

In some embodiments of the invention, only some of the poses from the above-mentioned first set of images may be used.

In some embodiments of the invention, a specific set of poses is used, as it is found to be sufficient for a majority of users.

In some cases, computing a user's measurements requires a different set of poses.

Reference is now made to FIGS. 2G-2J, which are a second set of example images taken during use of the example embodiment of FIG. 1.

The second set of images depicted in FIG. 2G-2J represents additional poses, either taken as a second set of poses, or taken individually and mixed in with the first set of poses, or other poses.

FIG. 2G depicts a person 150 in a pose with a leg on a chair.

It is noted that the pose depicted in FIG. 2G may be especially useful since the pose prevents the upper parts of the legs from touching each other. The pose of FIG. 2G enables detection and measurement of the top of the inner leg; and measuring the thigh.

FIG. 2G depicts a pose especially useful for imaging fat persons, which sometimes present a problem in identifying the top of the inner legs and a separation of the thighs.

FIG. 2H depicts the person 150 in a pose with an angle of about 70 degrees between hands and body, preventing the hands and chest from touching, and assisting to detect armpits and measure chest width.

FIG. 2I depicts a pose with the reference object 120 held to the side of the body, and not on the belly. In fat people, locating the reference object 120 on the belly puts it closer to the camera than the hands, neck, and other body parts.

FIG. 2J depicts a pose with the reference object 120 held above the head, and not on the belly.

It is noted that when the reference object 120 is held not in front of the body, the color of the reference object may optionally be chosen to be a different color, producing contrast with the background rather than or in addition to producing contrast with the person's clothing.

Additional poses are now described, but not shown:
sitting on a chair with the reference object in front of the body;
sitting on a chair with hands horizontally to the side;
sitting on a chair with hands down;
sitting on a chair with hands up;
sitting on a chair in profile, with hands down, optionally holding the reference object;
sitting on a chair in profile, with hands up, optionally holding the reference object.
sitting on a chair in profile, with one hand up and one hand down.

It is noted that sitting on a chair allows a distance from the camera be shorter, potentially useful in small rooms where a person cannot be completely imaged while standing.

The sitting on the chair potentially ensures that a person does not pose at a different distance from the camera in one pose on the chair than in another pose on the chair.

The sitting on the chair in profile potentially helps to make some hard measurements such as shoulders-to-hips distance and thigh length. Some chair poses accent a person's joints, for example, sitting accents the thigh-to-torso angle.

Some poses are selected so as to accent the joints, for example sitting, bending, distancing arms from the torso.

It is noted that it is also possible to image a pose in two images: a first image for the top half of the body, such as from hips to head, and a second image for the bottom half of the body, such as from hips to feet. It is noted that the reference object may be optionally be included in both images.

It is noted that the reference object may be placed at the front of the belly while posing in profile, imaging the reference object right next to the belly, which has a potential to improve accuracy.

Reference is now made to FIG. 2K, which is a simplified flow chart illustration of an example embodiment of the invention.

The flow chart of the embodiment of FIG. 2K is a flow chart where a set of poses is requested of a person in order to prepare a set of images, analyze the images, and provide anthropometric measurements.

(a) a computer optionally provides instructions to a person to pose in a specific pose for a camera to capture the person's image in the pose (160);

(b) a camera captures an image of the person in the pose (165);

(a) and (b) are optionally repeated, thereby instructing the person to pose in a set of poses, and capturing a set of images (170);

(c) the set of images is analyzed (175); and

(d) anthropometric measurements are optionally provided (180), based, at least in part, on the analyzing.

In some embodiments of the invention, the person is asked to provide personal, body-related information, and the set of poses is selected based on the information.

Some non-limiting examples of the body related information include:
height
weight
age;
gender.

In some embodiments of the invention, BMI is calculated. If the BMI is higher then a threshold the user is requested to pose in poses suitable for fat people, such as were described with reference to FIGS. 2G-2J.

In some embodiments of the invention the user is requested to pose using a first pose, or even a set of poses, such as the poses described above with reference to FIGS. 2A-2E. If, based on measurement results, the user is identified to be fat, then the user is requested to pose in additional poses, optionally poses suitable for fat people.

In some embodiments of the invention, if there is a difficulty to detect, or a low confidence in the detection of, key body locations such as the armpits and/or the space between the legs, the person is requested by the computer program to pose in additional poses.

In some embodiments of the invention, the person is guided in case the person did something wrong, which is detected by the computer program. For example, a message may be displayed on an interface screen saying: “your hands are not spread to the sides”; “Please turn on the lights”; or “The background is not suitable”.

In some embodiments of the invention the user is requested to pose using a specific pose, or even a set of poses, based on a specific clothing item the user may be considering. For example, a dress may requires less accurate leg length measurement. For example, a gown may require more accurate chest measurements.

In some embodiments of the invention the user is requested to pose wearing two or more sets of different clothes. For example, a woman may be advised to pose wearing different style bras.

In some embodiments of the invention, the person 100 using the embodiments gets instruction from the computer screen where to stand. Optionally, the computer screen displays what the camera sees, and optionally adds guide marks on the screen, so that the person 100 can place her body, using the guide marks, in a good location within the field of view of the camera.

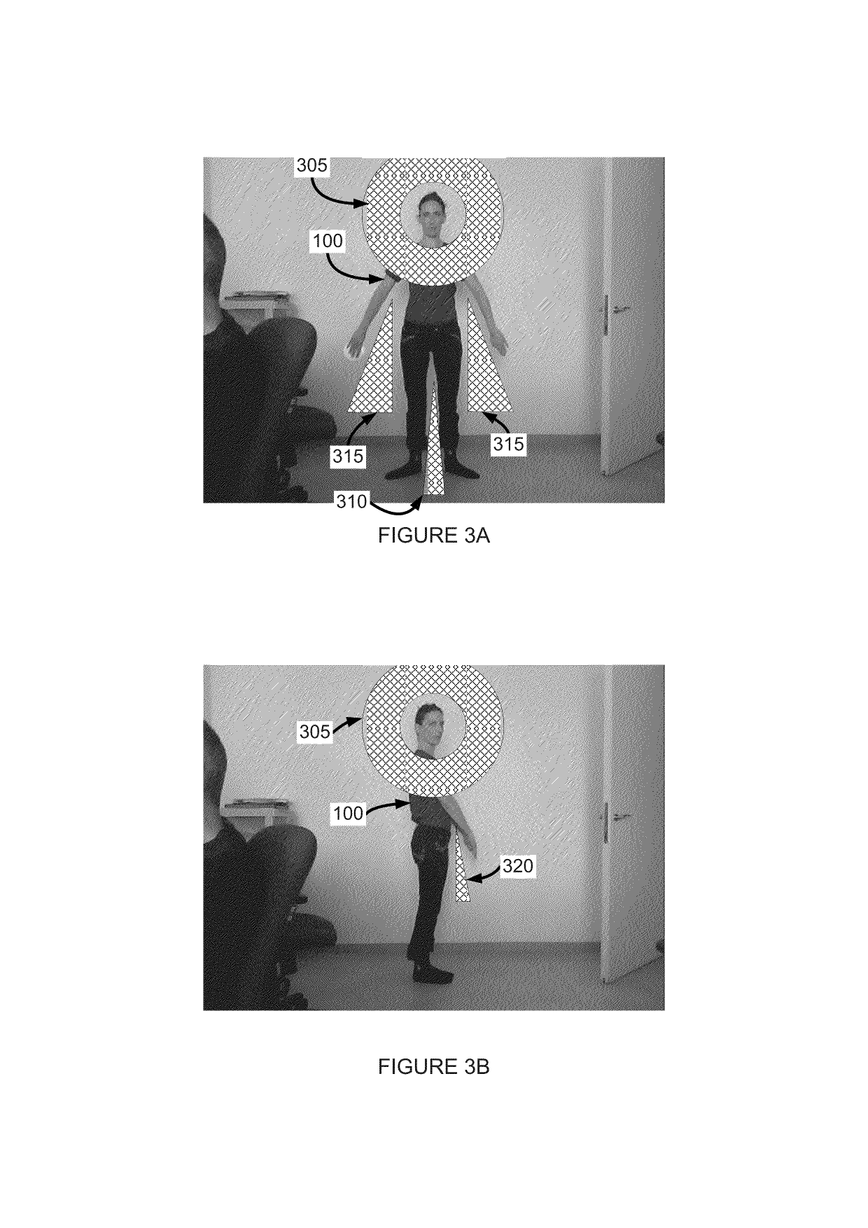

Reference is now made to FIGS. 3A-3B, which are example images of a screen displaying some positioning guides to a user of the example embodiment of FIG. 1. it is noted that in some embodiments of the invention, a user can see the image the camera images, optionally marked-up. A non-limiting example of such an embodiment is the person 100 looking at the screen of the laptop 105, which displays an image of its field of view as seen through a webcam in the laptop 105.

FIG. 3A depicts an image of the person 100 of FIGS. 2A-2E, and optional guiding marks 305 310 315 which guide the person 100 to place herself in a good location within the field of view of the camera.

The optional guiding mark 305 serves to locate the head of the person 100.

The optional guiding mark 310 serves to guide the person 100 to space her legs enough so an outline of the legs is optionally viewed all the way up to the crotch.

The optional guiding marks 315 serve to guide the person 100 to space her arms from her body enough so an outline of the arms and the body is optionally viewed clearly.

FIG. 3B depicts an image of the person 100 of FIG. 3A in a stance imaging her profile, and optional guiding marks 305 320 which guide the person 100 to place herself in a good location within the field of view of the camera.

The optional guiding mark 305 serves to locate the head of the person 100.

The optional guiding mark 320 serves to guide the person 100 to space her arms from her body enough so an outline of the arms and the body is optionally viewed clearly.

In some embodiments of the invention, an image of the background is taken prior to images of the person 100 within the background, and the person 100 is optionally guided by the guiding marks to stand in a location chosen such that there is good contrast between the person 100 and the background, that is, away from background objects whose image may merge with an image of the person.

In some embodiments of the invention, an image of a human avatar is displayed, with approximately a body type of the person 100, and the person is guided to place his/her body in the pose of the avatar, optionally fitting approximately within the shape of the avatar.

In some embodiments of the invention one or more images are analyzed, and anthropometric measurements of the person 100 are computed. The measurements are optionally initially computed in units of image pixels, optionally translated to units of length such as inches or centimeters, and optionally translated to clothing sizes.

The measurements optionally include measurements of object dimensions, object contour, object length, object volume, and object circumferences.

In some embodiments of the invention one or more of the following clothing sizes are available to be used: S, M, L, XL, XXL, and larger for infants, toddlers, children, women and men; neck circumference, sleeve length, waist circumference, trouser length, crotch height, bra size, cup size.

User Interface—Providing Results

In some embodiments of the invention a user is optionally presented with one or more of various anthropometric measurements, including sizing parameters based on the anthropometric measurements, such as the clothing sizes.

In some embodiments of the invention the user is optionally presented with results of the measurements after a while, such as after about 15 seconds, after about 10 seconds, 5 seconds, one second, or even less than one second.

In some embodiments of the invention the user is not presented with results of the measurements at this time, but sent to a shopping web page.

It is noted that measurements using an embodiment of the invention are already more accurate than manual measurements of some people.

In some embodiments of the invention, the measuring program optionally uses or even provides data about confidence/reliability of each measurement. By way of a non-limiting example, several images are taken of the same pose, and a difference in the measurements between different images optionally provides a measure of precision/accuracy of the measurement.

In some embodiments of the invention the same measurements are optionally taken from different poses, and if the measurements match, having a difference less than a threshold difference, then the measurements are considered reliable. In some embodiments of the invention the threshold difference is 2 centimeters, or 1 centimeter, or 2%, or 2% of a large measurement and 4% of a small measurement, or even a practical threshold such as a difference between two adjacent clothing sizes.

User Interface—Optional Tweaks

In some embodiments of the invention the user is optionally presented with an opportunity to tweak the clothing sizes.

In some embodiments of the invention the user is optionally presented with an opportunity to provide input as to the user's preference for clothing fit—loose in the legs, snug, tight, tapering, longer sleeves or shorter, tighter neck or looser, and so on. Optionally, the user may tweak any clothing size presented by the computer.

In some embodiments of the invention the user is optionally presented with an opportunity to provide input as to a clothing size of an article of clothing which the user knows, and an indication of whether the article fits tight, fits well, or fits loose.

In some embodiments of the invention, a simplified flow of a process of providing a person with anthropometric measurements, and/or clothing sizes, may be summarized as follows.

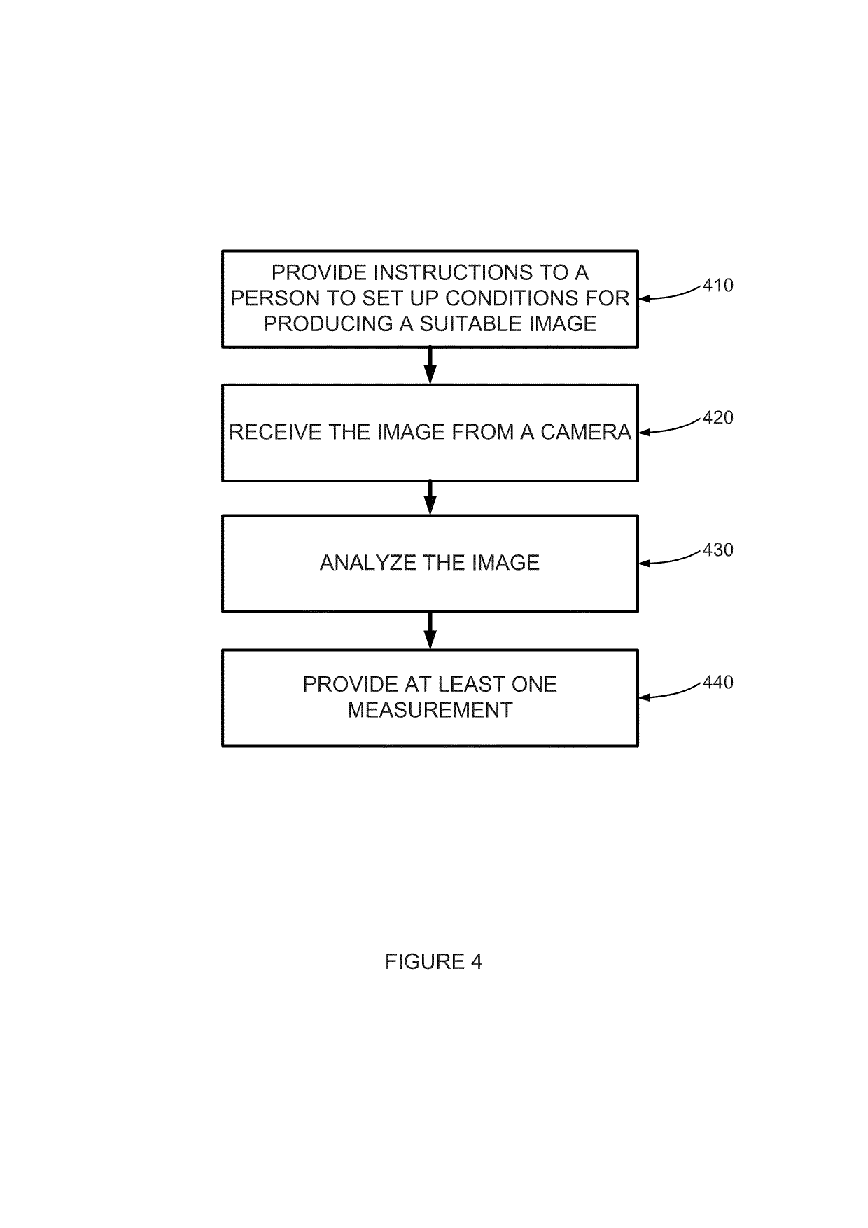

Reference is now made to FIG. 4, which is a simplified flow chart illustration of an example embodiment of the invention.

A computer program provides instructions to a person to set up conditions for producing a suitable image (410).

A computer program, either the above-mentioned computer program or a different computer program, receives the image from a camera (420), the image including at least part of the person's body.

The computer program analyzes the image (430).

The computer program provides the person at least one measurement (440) based, at least in part, on analyzing the image.

Image Processing

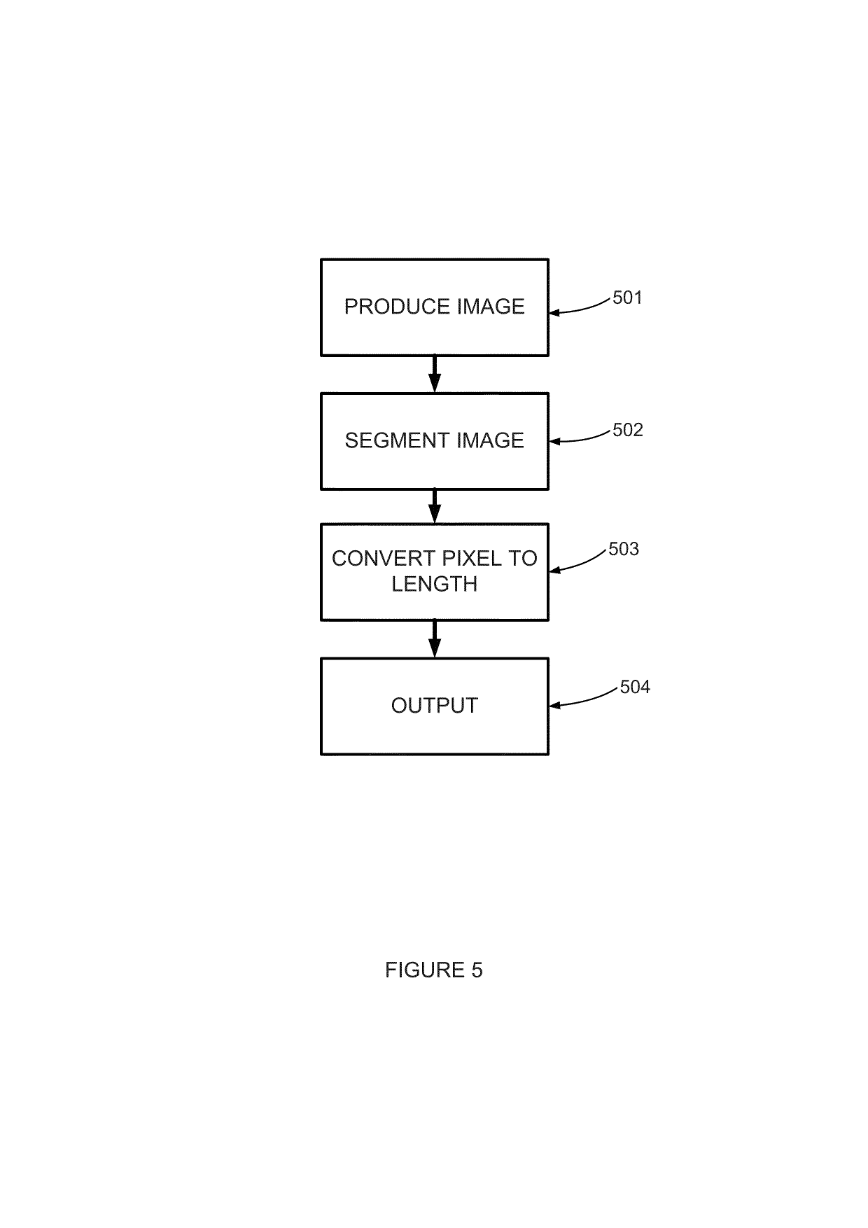

Reference is now made to FIG. 5, which is a simplified flow chart illustration of an example embodiment of the invention.

FIG. 5 depicts an example process of processing an image, or analyzing the image, as described above with reference to FIG. 4.

In an example embodiment of the invention, an image is produced (501).

In some embodiments of the invention, an image capturing device captures an image of a scene occurring in its field of view. In some embodiments of the invention, the output which the image capturing device produces is optionally a video. In some embodiments of the invention, the output which the image capturing device produces is optionally a series of pictures, or some other format which an image capturing device may.

The image is segmented (502), enabling an identification of a person's body relative to a background, and an identifying of portions of the person's body, such as a head, a neck, an arm, a thigh, a leg, and so on.

In some embodiments of the invention, an entire body is imaged, and identifying a portion of the body helps in identifying other portions, such as identifying the legs helps with indentifying the hands, and vise versa.

In some embodiments of the invention, a portion of a body is imaged, and identifying the portion of the body helps in identifying other portions within the image, such as identifying the arms helps finding the hands and vise versa.

The portions of the person's body are measured. A non-limiting list of anthropometric measurement includes: neck width, arm length, leg length, crotch height, waist width, and so on.

In some embodiments of the invention, neck width is optionally converted to neck circumference using a formula such as: neck circumference=X*neck width. In some embodiments of the invention, X is approximately 3.14 (π), and the formula is based on a circle model for the neck.

In some embodiments of the invention X is optionally larger than π, assuming that the width of the neck is smaller then the depth.

In some embodiments of the invention both the width and the depth of the neck are used, in a formula such as:

Neck circumference=X*(neck width+neck depth). In some embodiments of the invention X is optionally π/2.

Such formulae as described above may also be used for belly, chest, hip, thigh, and wrist circumferences, and in general a circumference of any body part.

An initial measurement is optionally made using pixels.

The segmentation optionally serves to detect an object for measurement which is positioned in the image. In some embodiments of the invention the measured object is a person, who optionally stands various poses according to instructions from a computer program. A computer program optionally detects the person, or measured object, in the image or series of images, and will segment the person from rest of the image.

In some embodiments of the invention measurement is done by identifying different body parts, or useful locations in a body, such as shoulders, and/or edges of the chest. After the locations have been identified, distances between the locations may be calculated. The useful locations may be identified directly, without segmenting the body.

The segmentation process optionally returns an image of the person, or a series of such images, or some other representation of the image of the person. Other representations include, by way of a non-limiting example, data in non-image-file-formats. For example, a list of pixels within the contour of the person, in which each body part or and clothing item that is worn by the person in the image is detected and is flagged to distinguish it from the rest of the image.

The measured object can be distinguished from the rest of the image in several ways. Some possibilities are: returning a two colored image, in which the measured object is colored in one color and the rest in a different color. Another possibility is returning an image, in which just the measured object is seen, or a list of all the pixels of the image belonging to an image of the person.

Measurements in units of pixels are optionally converted to units of length (503) such as inches or centimeters.

In some embodiments of the invention pre-existing information about the size of a reference object is optionally used to determine sizes of other objects in the image, and optionally of the measured object, or person.

The size of the reference object is known, so when detecting and segmenting the reference object from the background it is possible to convert between the size of the image of the reference object and a pre-known dimension of the reference object. For example, if the reference object is a CD, it is known that a diameter of a CD is 120 mm (12 cm). In case the CD is represented in the image by 24 pixels, it is computed that each image-pixel length is equal to 0.5 cm. Assuming that a user chooses a CD as a reference object, and that the reference object has been detected and segmented from the background, it is known that the CD's diameter is 12 cm, so it is computed that the length of each pixel is 0.5 cm.

The pixel-to-cm conversion which is described in the paragraph above is optionally used together with the segmented image retrieved in 502 to provide information on the size of the object in centimeters/millimeters. For example, assuming that the main object is a person, it is possible to compute that a part of his body that is 24 pixels long is actually 12 cm long.

Despite discussing the conversion of pixels in the images to the decimal system of measurement (cm, mm, etc.), the conversion can occur from pixel to other measuring units. For example, it is clearly possible to make the conversion from pixels to United States customary units (inch, foot, etc.).

The measurements are optionally presented as output to the person (504).

Possible outputs which are provided at the end of the process include:

Computed dimensions of the measured object—the computed dimensions are optionally returned in a table form, in which numerical data is presented, or are optionally returned in other possible form which demonstrate the computed dimensions to the user, such as, by way of a non-limiting example, presenting an avatar having the body dimensions of the user.

In some embodiments of the invention the computed dimensions, that is, the measurements of the user, are optionally saved in a database, and are optionally identified by user ID and/or a username. The data can optionally be recalled from the database based on demand.

In some embodiments of the invention the computed measurements of the user are used to determine a body type, and optionally the body type is clustered to a group of matching body types, such as slim or heavy, short or tall, and information may optionally be returned to the user as to which body type cluster he or she belongs.

Body Types

It is noted that when fat people put a reference object on their stomach, the reference object is closer to the camera than their shoulders, neck, hands, and so on. The difference in distance may be up to, for example, 20 cm closer. Over a typical camera-to-body distance of 2.5 meters, the difference is 8%. If the difference is not compensated for, the measurements may be computed to be 8% smaller.

In some embodiments of the invention, measurements are adjusted according to body type.

In some embodiments of the invention, measurements are adjusted according to belly width.

In some embodiments of the invention the user is optionally informed what color skin he/she has.

In some embodiments of the invention the user is optionally asked what color skin he/she has.

In some embodiments of the invention the user's dimensions are optionally matched with clothing dimensions, providing the user with a size he/she should wear, either from a specific clothing producer/retailer, or alternatively as a general clothing size suggestion.

In some embodiments of the invention the user's dimensions are optionally matched with clothing dimensions, and provided to a store, where the user will subsequently shop.

In some embodiments of the invention, using the computed measurements of a user, it is possible to cluster the user to a matching body type, and inform the user to which body type he or she is clustered. Based on the user's body type, with or without exact dimension, it is possible to inform the user which type of clothes he/she should wear. Based on the user's body type, with or without exact dimension, it is possible to inform the user how he/she should wear the clothes, such as, by way of a non-limiting example, “wear your jacket unbuttoned, it looks better on a larger person such as yourself”, or “wear this scarf tied around the hips”.

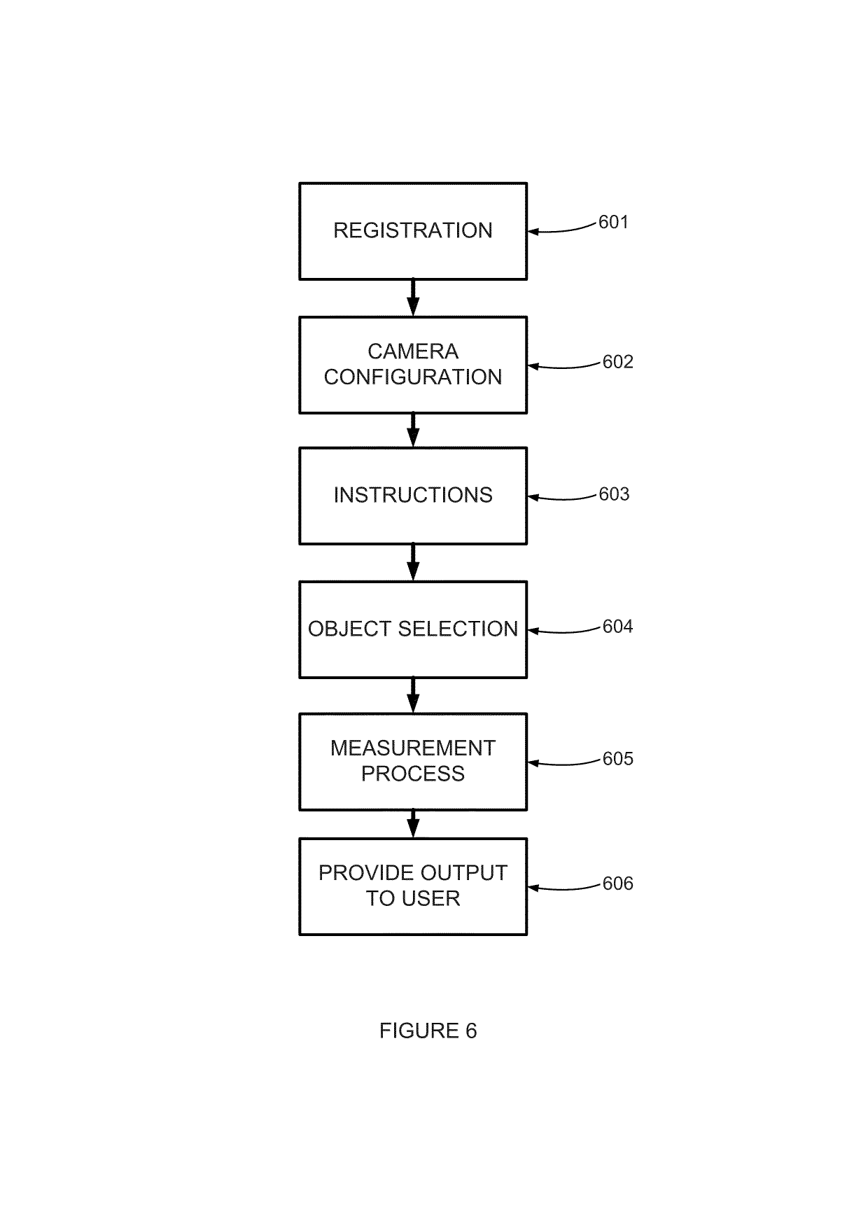

Reference is now made to FIG. 6, which is a simplified flow chart illustration of an example embodiment of the invention. FIG. 6 is a simplified flow chart from a user perspective.

A user optionally interacts with a registration page (601), in which the user is asked to register, possibly providing a user name and password.

Optionally, the user may also be presented with one or more of the following:
an introduction to the process awaiting the user;
information about the process awaiting the user;
information about the company providing the service; and
information about which clothes should be worn.

Optionally, the user may be asked to enter height, weight, age, and/or gender.

Optionally, the user may be asked how she/he likes to wear clothes (e.g. tight, loose).

Optionally, the user may be asked what size clothes she/he presently wears, providing an initial ball-park value for the measurements.

Optionally, the user may be asked about skin color or appearance.

Optionally, the user may be asked to give information about the room.

Optionally, the user may be asked give information about the reference object.

Optionally, the user may be asked to give information about the camera/computer/hardware.

The user is optionally presented with instructions and/or information about camera configuration (602), optionally how to configure desirable viewing conditions.

The image capturing device configuration optionally instructs the user to make sure that the system recognizes the image capturing device. The user may optionally be requested to confirm whether a real time image is presented on the screen. In addition, a possible action is optionally used as verification that the received image is or is not in a mirror mode, and other image related issues.

The user may also, optionally, be presented with instructions (603).

The instructions are optionally in the form of video, images, voice instructions, animation, and/or a combination of the above.

The user may optionally be presented with an instruction screen telling the user to select a known reference object from a list of suggested objects (604). In some embodiments of the invention, the user is asked to select a reference object from a list of objects. In some embodiments of the invention the user is asked to use a specific reference object.

The reference object, either predetermined or user-selected, may optionally be used as a part of the measuring process.

The actual measuring process is optionally performed (605). The measuring process is described in more detail with reference to FIG. 5 above, and also elsewhere in the specification.

Output of the process is provided to the user (606). The output is optionally the measurements of the user; an avatar of the user; the user's skin color; and/or selected services based on the information mentioned above and other data acquired from the user and the measurement.

In some embodiments of the invention:
Images and/or video of the person are optionally taken in several positions.
Images and/or video may or may not, optionally, include images taken without the person.
One or more images may optionally be taken from each position.
Positions may optionally include a position, or more than one position, in which one or more reference calibration objects with known dimensions are on/near/held by the person.

In some embodiments of the invention the calibration object is selected from the following group of objects:
a CD/DVD.
an A4 page.
a page or an item with reference markers visible thereon.
a circular object, such as a disk. A potential advantage of a disk shaped object is that its projected image on a camera plane is an ellipse whose large diameter corresponds to the original disk diameter.
a ball. A potential advantage of a ball is that its projected image on the camera plane is a disk with a diameter corresponding to the diameter of the original ball.
a rectangular object.

In some embodiments of the invention, the calibration object is an object whose dimensions, or some of them, or one of them, are known by the computer program, or has markings upon it whose length or width or distance are known.

In some embodiments of the invention, the reference object is a sheet of paper with reference markings, printed by a user.

Separation Between the Person and the Background

In some embodiments of the invention, one or more standard segmentation algorithms can be used, among which are thresholding methods, region growing, split and merge methods, and others.

In some embodiments of the invention, a segmentation algorithm is used whose input includes areas in an image which, based on position instructions optionally provided to the person, are known to belong to an image of the person, and/or are known not to belong to the image of the person.

Some methods used to implement a segmentation algorithm include methods described in the above-mentioned articles:
G. Friedland, K. Jantz, R. Rojas: SIOX: Simple Interactive Object Extraction in Still Images, Proceedings of the IEEE International Symposium on Multimedia (ISM2005), pp. 253-259, Irvine (California), December, 2005.;
G. Friedland, K. Jantz, T. Lenz, F. Wiesel, R. Rojas: Object Cut and Paste in Images and Videos, International Journal of Semantic Computing Vol 1, No 2, pp. 221-247, World Scientific, USA, June 2007; and
Livewire (MORTENSEN, E. N.; BARRETT, W. A. Intelligent scissors for image composition. In: SIGGRAPH '95: Proceedings of the 22nd annual conference on Computer graphics and interactive techniques. New York, N.Y., USA: ACM Press, 1995. p. 191-198.

In some embodiments of the invention, change detection algorithms are optionally used, detecting a person's image by analyzing a change between an image with the person, and the image without the person. Some examples of such change detection algorithms are described in above-mentioned: “Richard J. Radke, Srinivas Andra, Omar Al-Kofahi, and Badrinath Roysam: Image Change Detection Algorithms: a systematic Survey, IEEE TRANSACTIONS ON IMAGE PROCESSING, VOL. 14, NO. 3, MARCH 2005”.

In some embodiments of the invention, change detection is optionally enhanced using prior knowledge about the person's position, based on the instructions provided to the person when posing for the camera.

In some embodiments of the invention, edge detection algorithms are optionally used, by way of a non-limiting example such as described in above-mentioned: J. M. Park and Y. Lu (2008) “Edge detection in grayscale, color, and range images”, in B. W. Wah (editor) Encyclopedia of Computer Science and Engineering, doi 10.1002/9780470050118.ecse603.

In some embodiments of the invention, edge detection is optionally enhanced using prior knowledge about the person's position.

In some embodiments of the invention, edge detection is optionally enhanced by reviewing several potential edges, and choosing between the potential edges based on human body modeling. For example:
edges representing a symmetric shape are optionally preferred;
edges resulting in relatively gradual change in arms length and width are optionally preferred;
edges resulting in organ dimensions obeying a human body model are optionally preferred, such as obeying: hand length is smaller than leg length; hand length is between r₁ times leg length and r₂ times leg length).

In some embodiments of the invention, several different segmentations and/or computation methods algorithms are used. If the different methods produce different results, results are optionally selected according to body modeling:

In some embodiments, one set of results is chosen—a set which better fits body modeling. For example, a set in which an approximate relationship between different body parts is maintained, such as, for example: waist circumference <belly circumference; arm length˜=

A*leg length.

In some embodiments, each measurement is chosen separately according to its closeness to an a priori estimate provided by, for example, one of:
an approximation calculated from user input (gender, height, weight, age, shirt size);
a previous old measurement;
matching, using body modeling statistics, with measurements which are reliable, such as measurements which are very similar when computed by different sets of methods.

In some embodiments of the invention, face detection is optionally used to find the location of the head and it approximate size and borders. The location is optionally used as input to other segmentation methods to enhance their precision. By way of a non-limiting example, the Viola Jones algorithm can be used for the face detection.

In some embodiments of the invention, motion detection algorithms are optionally used, in which the person is separated from the background based on motion detection, detecting the person moving relative to the background.

In some embodiments of the invention, motion detection is optionally enhanced using prior knowledge about the person's position.

In some embodiments of the invention, motion detection is optionally enhanced by using a human body model.

In some embodiments of the invention, a 3D camera optionally enhances segmentation by supplying depth information.

In some embodiments of the invention, a stereo camera optionally enhances segmentation by supplying a pair of images from slightly different angles.

In some embodiments of the invention, 2 or more cameras are optionally used, potentially enhancing segmentation.

In some embodiments of the invention, multiple cameras are optionally used to provide depth information.

In some embodiments of the invention, multiple cameras are optionally to enhance at least some of the above-mentioned segmentation methods, optionally using the information which the multiple cameras provide from slightly different or substantially different view points.

In some embodiments of the invention, a camera which moves optionally supplies 3D information, as well as multiple viewpoint information.

In some embodiments of the invention, special cloths or cloths with known marks or markers are optionally used to improve segmentation precision.

In some embodiments of the invention, the user wears black clothes, and the images are taken against a white and/or light and/or uniform background.

In some embodiments of the invention, a segmentation method optionally uses detection of human colored skin, and thus optionally detects and separates exposed parts of the person's body from a background.

In some embodiments of the invention, detection and separation of a calibration object and the rest of the image are optionally performed by one or more of the above-mentioned segmentation methods.

In some embodiments of the invention, the segmentation methods optionally use prior information about the calibration object, including its shape and its projection on the image plane.

In some embodiments of the invention, the calibration object is a disk, and its projection is an ellipse, for which suitable algorithms for ellipse detection are optionally used. A non-limiting example of an ellipse detection algorithm is described in above-mentioned: W.-Y. Wu and M.-J. J. Wang, Elliptical object detection by using its geometric properties, Patt. Recog., 26-10 (1993), 1449-1500; Kanatani, K., Ohta, N.: Automatic Detection Of Circular Objects By Ellipse Growing. Int. J. Image Graphics (2004) 35-50; and Duda, R. O. and P. E. Hart, “Use of the Hough Transformation to Detect Lines and Curves in Pictures,” Comm. ACM, Vol. 15, pp. 11-15 (January, 1972).

In case of shapes whose edge includes 1 or more straight lines, such as, by way of a non-limiting example, an A3 or A4 page, their projections are projected as straight lines, and line detection algorithms are optionally used. Some examples of such algorithms which may optionally be used, are Hough transform and edge detection based algorithms, such as described in above-mentioned R. Gonzalez and R. Woods Digital Image Processing, Addison-Wesley Publishing Company, 1992, pp 415-416.

In some embodiments of the invention, the expected position of the calibration object optionally serves to limit the search area for the calibration object.

In some embodiments of the invention, the expected position of the calibration object optionally serves to assign different probabilities to discovering the calibaration object in different areas of an image.

In some embodiments of the invention, an expected size of the calibration object in the image is optionally estimated using the object size, the expected distance from the camera, and optionally an angle in which the object is expected to be held.

In some embodiments of the invention, the expected size is optionally used for eliminating false candidate detections; integration in the detection algorithm; and calculating a pixel size.

An example computation using the calibration object:

a pixel size=a number of pixels in a diameter of an image of the calibration object, divided by a physical length of the diameter of the object.

In some embodiments of the invention, instead of diameter another measure of the object is used, such as a perimeter or an area, and the above formula is adjuxted accordingly.

In some embodiments of the invention, instead of a calibration object, information supplied by the user is optionally used for calibration. For example, a height of the person being measured, or an arm length, or a distance between a floor and the ceiling. The calculation is similar to the calculation used with a calibration object.

In some embodiments of the invention, information from the camera or another appliance is used for calibration. For example:

Distance of the object to the camera and camera characteristics such as focal length are optionally used to calculate the pixel size. The distance of the object to the camera is optionally provided by several methods, among which are:

Using a 3D camera;

Using multiple cameras, by knowing their characteristics and relative location;

Using a moving camera;

Using external appliances such as laser based distance measurement; and

placing the camera in a distance such that its horizontal, and/or vertical, and/or even diagonal, field of view covers a known distance.

In some embodiments of the invention, instead of using a pixel size, equivalent information such as a combination of camera-person distance and camera field of view, optionally as an angle, or raw data is stored, which can be used to calculate the pixel size, and to calculate body measurements without directly calculating a pixel size.

Optional Detection of Key Points on a Body

In some embodiments of the invention, optional key points of a body are detected. The key points include, for example, the wrist, an edge of the shoulder, sides of the neck, the hip, the chest, the waist, the belly, the biceps, and a top and a bottom of inner and outer legs.

Key point detection is optionally done using properties of the key points, and/or a model of the human body, such as, for example:
the neck in the narrowest in its area of the body;
the shoulders are located where the body edge changes from relatively vertical to relatively horizontal; and
the waist is narrow, the belly is wider;

In some embodiments of the invention, key point detection optionally relies on known relationships between the key points, such as:
the chest is higher than the belly;
the wrists are in general narrower than the neck and the biceps; and
the two shoulders are in general of similar height.

In some embodiments of the invention, a distance in pixels between the key points is measured, and optionally converted to cm, or some other unit of length, using the above-mentioned pixel size information.

In some embodiments of the invention, Euclidian distance is used.

In some embodiments of the invention, distance along a line connecting edge points is used.

In some embodiments of the invention, information about the human body is optionally used to improve measurement precision. The information is used, for example:
for detecting erroneous, inconsistent measurements;
for choosing between several options, such as when an edge is not clear, according to how much the options fit an a priori knowledge of the human body, or a knowledge of the human body combined with measurement of other body parts;
for calculating circumferences from distances using human body modeling; and
for approximation to an ellipse or to other shapes.

In some embodiments of the invention, human anthropometric data tables resulting from measurements, optionally including manual measurements using a measurement tape, of a large number of people, containing data such as width, depth, and circumference, are optionally used to derive a useful formula for converting measured lengths to circumference, and/or are optionally used to directly estimate circumferences from measured lengths, optionally by looking up people with similar length measurements.

In some embodiments of the invention, body modeling is optionally used to enhance measurement by using a priori information together with several measurements to derive a more accurate measurement. By way of a non-limiting example, body modeling together with weight, height, neck circumference, chest depth and chest width is optionally used to estimate more accurate chest circumferences.

Optional Body Poses

In some embodiments of the invention, several poses of a person are images and used for calculating measurements.

In some embodiments of the invention, a combination of front, and/or back, and/or profile views of a person's body are used for image capture.

In some embodiments of the invention, both right and left profile views of a person's body are used for image capture.

In some embodiments of the invention, image capture is performed using poses presenting different angles of the body, such as 45 degree presentation rather than just front, back, and/or profile. In some embodiments, angle poses are used to improve measurement accuracy. By way of a non-limiting example, three images may be used—formtal, profile, and 45 degrees, and a circumference calculated as follows: neck circumference=(neck width+neck depth+nech-width-at-45-degrees)*π/3.

Some non-limiting example poses are now listed:

First position: front, hands at about 40 degrees, legs slightly open. Head chest and hips are straight facing the camera, palms facing the camera or back.

It is noted that open legs and hands can help the segmentation to separate images of the legs and hands from an image of the background.

It is noted that facing the camera potentially aids horizontal measurements to be good estimations of the width of the neck, chest, waist, belly, etc.

It is noted that a broad side of the palms facing the camera, front or back of the palms, potentially helps detect a location of the wrists, due to a change in width.

It is noted that having the hands not too high potentially makes a person, including the person's hands, be located in the middle of an image, and too far left or right, decreasing inaccuracies resulting from camera distortions.

The first position is potentially useful for measuring arm and leg lengths, width of neck, belly, chest, biceps, and hips.

Second position: profile, hands down. It is noted that hands down potentially helps prevent the shoulders from hiding the neck. The second position is potentially useful to measure the belly, neck, hips, and legs.

Third position: profile, hands up. It is noted that having the hands up is potentially useful so that the hands do not hide the chest, waist, and belly. The third position is potentially useful for measuring the belly, chest, hips, and legs.

Fourth position: front, holding a reference object such as a CD on the belly. It is noted that locating the reference object on the belly potentially helps locating and/or segmenting the reference object, whose approximate location is known, whose background is a shirt, optionally of contrasting color with the reference object.

Fifth position: no person, just the background.

In some embodiments of the invention, the poses are optionally poses where a whole body is viewed by the camera, such as the poses depicted in FIGS. 2A-2E.

In some embodiments of the invention, the poses are separate poses for an upper and lower part of the body, and/or other separation of poses.

It is noted that some potential advantages of having only part of a body in an image are:
that it enables a user to be close to the camera, enabling use of the measuring method in a small space, such as a small room and/or apartment, where a user cannot be far enough from the camera; and
that it potentially provides a higher resolution image of a body part, which may result in higher precision.

Not Only Clothing

Embodiments of the present invention have been mostly described with reference to determination of clothing sizes. However, anthropometric measurements have more uses, which are contemplated with reference to the anthropometric measurements. Some non-limiting example uses of the anthropometric measurements include: clothing sizes, bicycle sizes (frame size, setting seat height, adjusting handlebars, and so on), sizing and adjusting crutches, hat sizes, belt length, sizing and adjusting military equipment, and sizing and adjusting backpacks.

In some embodiments of the invention, body measurements are used to keep track of a diet.

In some embodiments of the invention, body measurements are used to size bicycles.

In some embodiments of the invention, body measurements are used to size car seats for a car buyer.

In some embodiments of the invention, body measurements are used to aid a dating service—by providing an answer to body types, sizes.

In some embodiments of the invention, gyms optionally use the body measurements to identify problem zones, for recommendations for training, and for tracking the training.

In some embodiments of the invention, the game industry uses body measurements to produce people's avatars with proper proportions.

In some embodiments of the invention, organizations, such as the military, optionally use the body measurements to provide people with clothing such as uniforms.

In some embodiments of the invention, body measurements are used to assist in identifying people in images and/or videos.

In some embodiments of the invention, anthropometric measurement data which is accumulated by a company are optionally used for designing products which fit people better, such as chairs, door knobs, and clothes.

In some embodiments of the invention, foot measurements are performed, optionally for aiding in shoe purchase.

In some embodiments of the invention, head measurements are performed, optionally for aiding in fitting glasses.

In some embodiments of the invention, hand measurements are performed, optionally for aiding in fitting rings.

In some embodiments of the invention, body measurements are performed, optionally for aiding in medical diagnostics.

In some embodiments of the invention, body measurements are performed, optionally for providing a user with health-related advice, such as: “you are too fat”, “you need a diet”, “it seems that you are losing weight, go see a doctor”, “one of your shoulders is higher—you need physiotherapy”.

A Distributed System for Anthropometric Measurements

Referenced is again made to FIG. 1. FIG. 1 depicts a laptop 105, which may include all parts of a computerized system for managing a person's measurements. The laptop 105 may include: a user interface unit for providing instructions to the person 100 to set up conditions for producing a suitable image and for accepting input from the person; a camera for capturing and sending the person's image to the system; and a computation unit for computing the person's anthropometric measurements based, at least in part, on the image.

A different embodiment of the invention is now described.

Reference is now made to FIG. 7, which is a simplified block diagram illustration of an example embodiment of the invention.

FIG. 7 depicts an example desktop computer 705, connected to a webcam 710. The computer 705 is optionally connected to a server 715 via the Internet 720.

In some embodiments of the invention, the desktop computer 705 runs a program providing a user interface unit for providing instructions to the person 725 to set up conditions for producing a suitable image and for accepting input from the person 725.

The webcam 710, which is functionally connected to the computer 705, serves for capturing and sending the person's image to the computer 705, which sends the person's image via the Internet 720 to a computation unit in the server 715 for computing the person's anthropometric measurements based, at least in part, on the image. Optionally, the computation unit in the server 715 sends measurement results to the user interface unit in the desktop computer 705.

In some embodiments of the invention, the computer 705 computes the person's anthropometric measurements based, at least in part, on the image, and sends the measurement results via the Internet 720 to the server 715.

In some embodiments of the invention, the program providing the user interface unit runs on a web browser in the computer 705.

In some embodiments of the invention, the program providing the user interface unit is a downloadable application.

In some embodiments of the invention, the program providing the user interface unit to run on the web browser is provided from a web site of a company set up to provide anthropometric measurements services.

In some embodiments of the invention, the program providing the user interface unit to run on the web browser is provided from a web site of an on-line store selling products which are fitted to the user 725 based, at least in part, on the user's 725 anthropometric measurements. Such an on-line store may be a clothing supplier, and/or even a bicycle store.

In some embodiments of the invention the server 715 includes a database (not shown). The database optionally stored users' 725 measurements, and provides a service to the users 725 by storing their measurements, and optionally by providing their measurements to third party on-line stores when the users 725 are shopping for measurement-related products.

In some embodiments of the invention, the server 715 acts as a business-to-consumer (B2C) facilitator, the user 725 acting as the consumer, and the on-line store acting as the business.

In some embodiments of the invention, the server 715 acts as a business-to-business (B2B) facilitator, the server 715 acting as a first business (a service provider) and the on-line store acting as a second business.

A measuring system constructed as an embodiment of the present invention may be a merchant's system and/or a third party provider system. The functions and operations of the measuring system may be performed entirely within the merchant's system, partly within the merchant's system and partly within a third party provider's system, or entirely within the third party provider's system.

In some embodiments of the invention the functions and operations of a measuring system are included within a commercial entity—a company which provides the service of anthropometric measurements, saves the measurements, and uses the measurements for business purposes.

In some embodiments of the invention, the company uses the data it accumulates to provide suggestions to a user, such as: what products did other, similar users search for, and in general uses a crowd intelligence based on users of the system.

In some embodiments of the invention, the company optionally integrates visualization services, to simulate what a user will look like, wearing a certain item of clothing.

In some embodiments of the invention, the company optionally provides an API to other service providers to offer services based on the company information.

In some embodiments of the invention, users receive a user ID. With their user ID, users are able to login in shops and platforms which belong to the company's network. With the user ID, a person can log in to an iframe optionally located in other companies' web pages.

In some embodiments of the invention the company's business model is B2B and pay-per-use based, and retailers are optionally charged per user login. The business model is a model accepted by both key and minor retailers.

A few business scenarios using an embodiment of the invention are now described. In the scenarios, a company providing measurement services is named UPcload.

An example scenario is describes a user saving measurement data in what is termed an UPcload profile. The UPcload profile is optionally stored in a database.

In some embodiments of the invention, the UPcload profile includes one or more of a user's measurement, optionally stored over time; the user's clothing preferences; optionally a user's behavioral pattern, including data such as which items the user browsed, how long the user spent browsing each item, and user preferences, such as described above as tweaks.

In some embodiments of the invention, at least some of the following data is kept in an UPcload profile.

Data about a person's appearance: for example height, weight, skin color, body shape, complete body silhouette, posture, eye color, proportions of facial features, proportions of measurements of the person's body.

Data about a person's clothing preferences: for example which kind of clothes the person prefers, which colors, in which style and/or fashion (such as formal, elegant, sport elegant, rap style), how the person prefers the clothes to fit (tight, loose), important aspects of the fit (e.g. should cover/reveal stomach, extra-long sleeves), who are the person's fashion idols.

Data about a person' current wardrobe: for example which kind of clothes does the person currently possess, and in which sizes.

Data about a person's connection with other persons: for example who are other people which the person is connected to? (persons which a user is connected with optionally reveal their dimensions to the user).

Data for forming and displaying an avatar of a person: A person may produce or select an avatar of himself, and save the avatar as a “profile avatar”. A person may optionally produce or select an avatar of himself with same body measurements, yet different face, hair, etc.

Data about a person's shopping patterns: for example in which stores the user buys clothes, how often does the user buy clothes, what items does the user look for, what the user ended up buying, what the user returned, the user's comments on stores and about items the user bought.

Geographical and demographic data about a person and about groups of persons: for example where a person comes from, the person's age, gender, race, income level.

Data about cultural differences: for example. How shopping behavior patterns change from place to place.

Data about a person's payment details: for example access to payment methods.

In some embodiments of the invention the user may link his/her profile to other users' profiles, and the UPcload profile optionally includes which other users a user buys for and/or is linked to.

In some embodiments of the invention online data on clothing items is stored, such as, by way of a non-limiting example:

a. Serial number.

b. Item description.

c. Type of clothing (e.g. t-shirt).

d. Price level.

e. Fabrics.

f. Dimensions.

g. Producer wearing suggestion.

h. Complementary clothes.

i. Producer.

j. Cut.

k. Laundry instructions.

l. style.

m. An ideal body structure and anthropometric dimension for each clothing item.

n. additional information which a producer knows about the item.

o. possible information known about the producer.

p. information known about the people which should wear the item.

q. information known about the people who do wear the item, optionally their opinions about the item.

In some embodiments of the invention, a user in provided with information, a prediction, of how an item of clothing will fit, either in addition to a size suggestion, or even instead of a size suggestion. In some embodiments of the invention, the user is presented with information how the item fit, and the user is optionally allowed to order the item, or request a different size and/or item to be evaluated for fit.

A non-limiting example of the above fit prediction is now described from a user's perspective.

The user selects an item of clothing that he is interested in. Optionally, the user is also asked for preferences. Some possible, non-limiting examples of questions are: “do you like tight or loose?”, “how long do you prefer the sleeves?”, “what length do you prefer?”, “will you wear the shirt open at the neck?”, “tucked or not?”

The user is then optionally displayed an indication of how the item fit, optionally displaying more than one size and the predicted fit for each of the sizes.

In various embodiments of the invention, the indication may take different forms. In one example embodiment the fit prediction displays what gap is predicted between the user's body and the item of clothing. The gap may be described in qualitative terms, such as loose/snug, and/or in qualitative terms such as centimeters of gap, and/or by displaying the user's image, or avatar image, or a drawing, with colors indicating tightness of fit: red—tight, green—ok, blue—loose.

In some embodiments of the invention a tightness scale is used, to present the user with the fit prediction. The scale optionally ranges from unwearable (too small) to too wide/long. A fit prediction is positioned on the scale.

If the user changes preferences, the size suggestions optionally adjust correspondingly. By way of a non-limiting example, if a user states that he likes his clothes tight on the body, clothes that are 8 cm wider than the body, are considered loose, whereas if a user states that he likes the clothes loose on the body, the user receives a loose indication only when the clothing item is 18 cm wider on the body.

In some embodiments of the invention, the user is optionally displayed what other people with similar anthropometric dimensions look like wearing the item which the user chose.

In some embodiments of the invention the user is optionally displayed what similar people, dimension-wise, look like wearing the item the user chose, and a difference grade from the similar people, and optionally also a digital visualization of the similar people wearing the item.

In some embodiments of the invention the user receives the above-mentioned information and indicates a preferred size based on the information, that is, the user does not receive a size which fits, but assistance in choosing a size.

In some embodiments of the invention the following method is used to make a fit prediction. The fit prediction is optionally based on a difference between item dimensions and user body dimension. For example, to predict the fit on a chest, the item's size dimension at the chest (e.g. 100 cm) less the user's chest circumference (e.g. 96 cm) is taken. The difference is 4 cm. 4 cm is an example level of fit between the clothing item and the user's body.

In some embodiments of the invention, UPcload defines ranges of cm differences from a user's body, to provide fit predictions. A non limiting example of a conversion table for fit predictions is Table 1 below.

TABLE 1

| 1 | 2 | | 4 |
|---|---|---|---|
| Cm | Tightness | 3 | Tightness scale |
| difference | level | Color | [0-8] |
| Up to −4 | Too tight | Black | 0 |
| | (unwearable) | | |
| −4 to 0 | Tight | Red | 2 |
| 0 to 8 | Standard | Green | 4 |
| 8 to 16 | Loose | Blue | 6 |
| 16 and above | Too loose | Black | 8 |

Table 1 includes the following four columns. In some embodiments only some if the columns are implemented, and/or other columns providing similar information are used. Column 1 indicates the difference between a dimension of the clothing item and the same dimension of the user. Column 2 indicates a tightness level using words. Column 3 indicates the tightness level using names of colors, which are optionally used in a display to display a level of tightness on an image. Column 4 indicates a numeric level of tightness, by way of a non-limiting example using a scale of 0 (too tight) to 8 (too loose).

Table 1 is a non-limiting example of using dimensions with reference to a human bust. Fit predictions for other anthropometric measurements optionally use a similar table with different numbers in column 1.

In some embodiments of the invention, the numbers in column 1 take into account additional data, such as, by way of some non-limiting examples, fabric yarn type, fabric type, fabric weave type.

For example, certain fabrics have a strong influence on how they should be worn. Based on this, the fit prediction adjusts the number in column 1.

For example, spandex should be tight on the body. For spandex a difference of 0 cm may be OK, and the values in Table 1 will change to those of Table 2 below:

TABLE 2

| 1 | 2 | | 4 |
|---|---|---|---|
| Cm | Tightness | 3 | Tightness scale |
| difference | level | Color | [0-8] |
| Up to −8 | Too tight | Black | 0 |
| | (unwearable) | | |
| −8 to −4 | Tight | Red | 2 |
| −4 to 0 | Standard | Green | 4 |
| 0 to 8 | Loose | Blue | 6 |
| 8 and above | Too loose | Black | 8 |

In embodiments of the invention, different factors are optionally considered when predicting how an item fit a user's body. The factors optionally influence values in the table. For example, if a user states that he wants clothes which are loose, values in columns 2 to 4 of the table are adjusted down a row, so what is tight for one person, is considered too tight for the person who wants loose clothes.

By way of a non-limiting example, geographical considerations may influence the able, as people in some countries don't wear tight clothes at all.

In some embodiments of the invention, UPcload optionally does not display a user clothing items which are too tight and/or too loose.

In some embodiments of the invention, UPcload stores and analyzes data accumulated about people and their preferences, optionally to present to a user what other people bought and wear, so the user can interpret that he may also be likely to wear a certain size/item/fashion.

A few scenarios of using an embodiment of the invention are now described, with reference to a user and a business. A company providing measurement services is named UPcload.

In a first scenario, a user forwards measurement data to a store, and the store provides the user with clothes based on the measurements, whether ready made clothes in appropriate sizes, or even tailor made clothes.

In a first scenario, a user forwards measurement data to a clothing designer, and the designer provides a store with a right size and model for the user.

In a second scenario, a user enters an UPcload website, and is enabled to browse clothes which fit the user through UPcload. If the user sees a product which he wants to buy, the user is transferred to a website of a shop which sells the product, or else the user buys the product through UPcload, optionally under an affiliate system. The shop fulfills the order. Optionally, the user is displayed personal advertisements based on measurement, such as shops for the user's body type, and/or clothing items for the user's body type.

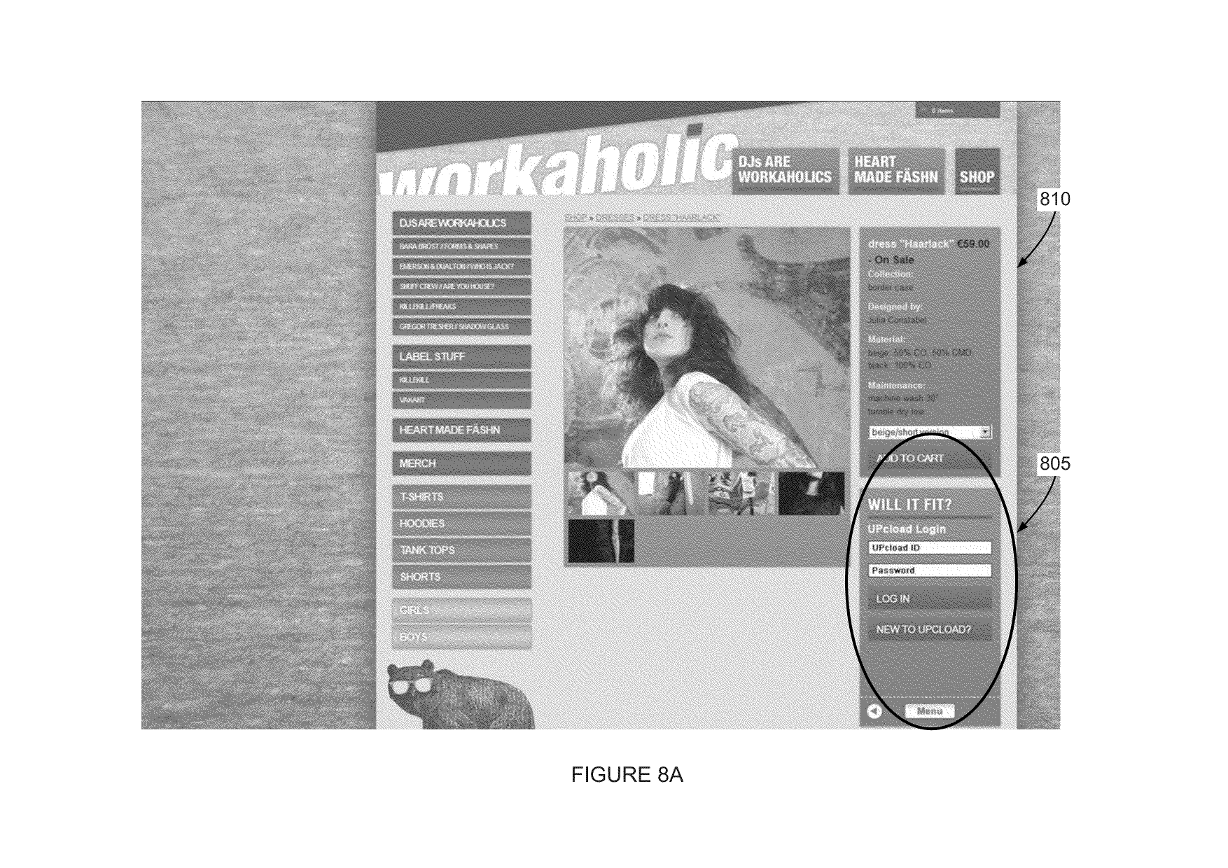

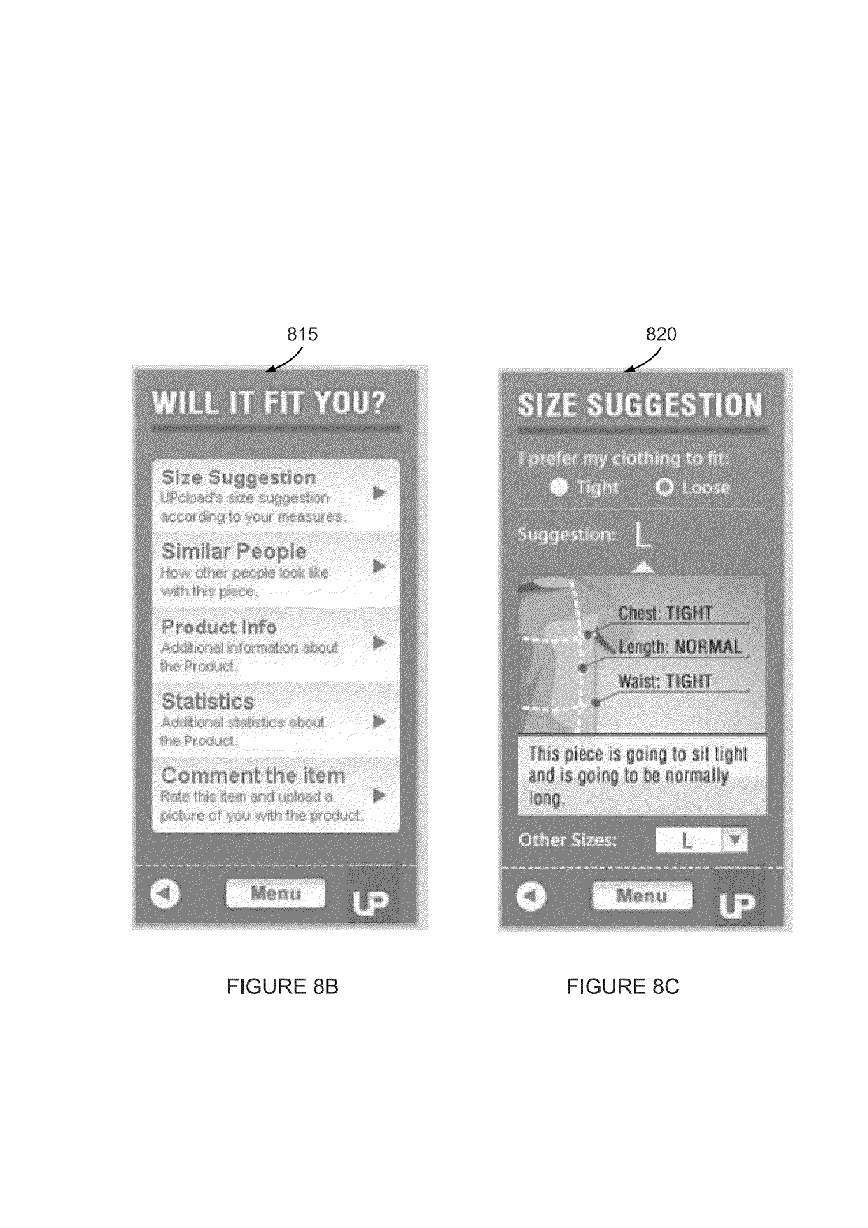

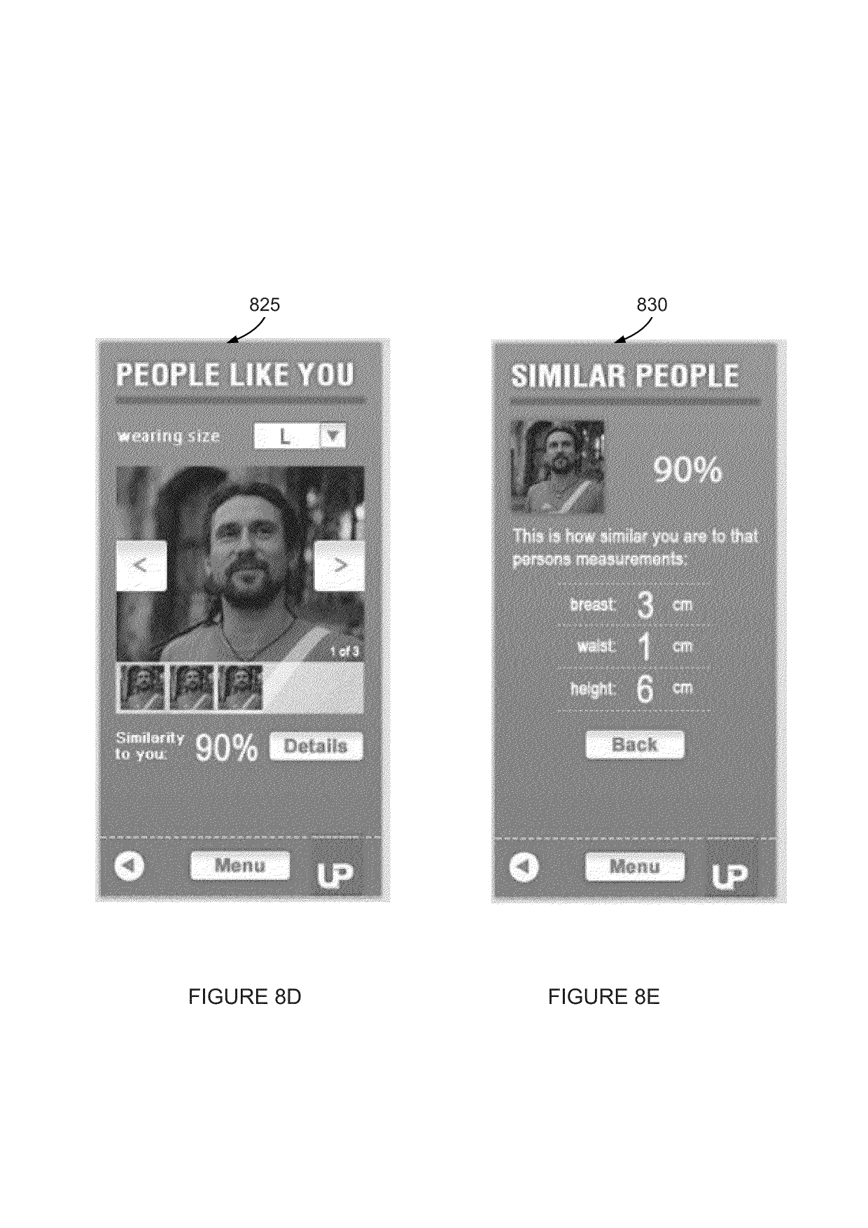

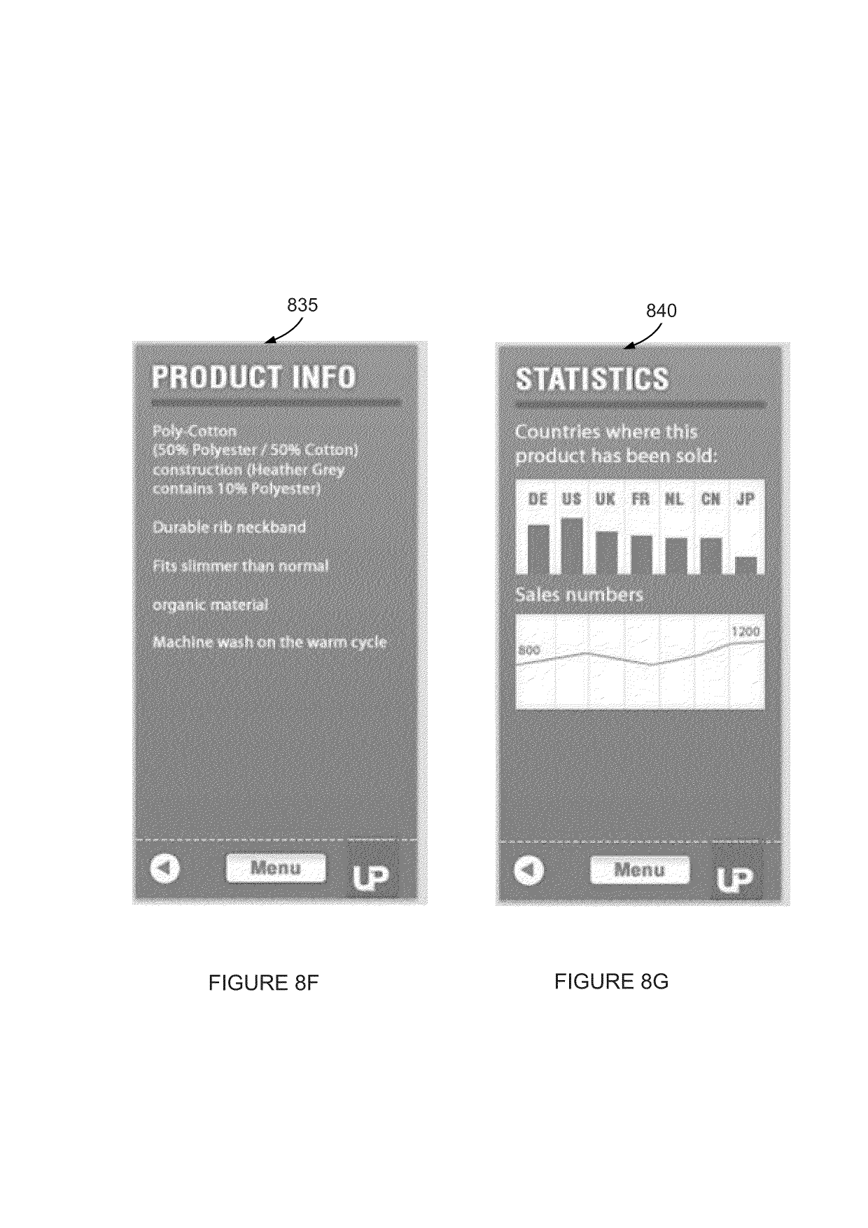

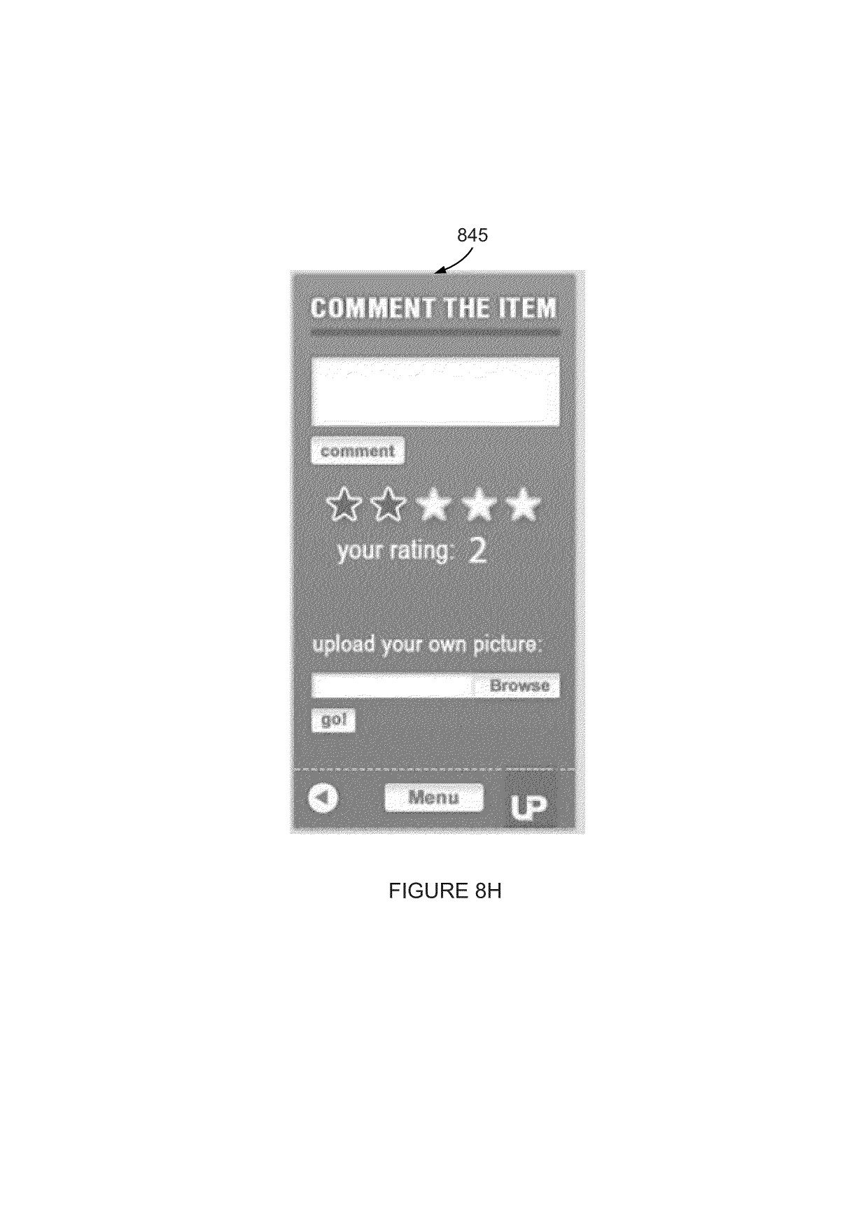

In a third scenario, UPcload shows up as one or more frames embedded in a web page of a website belonging to an entity other than UPcload. Such frames are described in more detail below, with reference to FIGS. 8A-8H.

In a fourth scenario, a web store produces an application interface, an API, which connects UPcload and the web store, such sizing data is pulled from UPcload servers and is integrated with web pages in the web store.

In a fifth scenario, UPcload produces a list of persons as a purchasing group, based, at least in part, on their similar body measurements, and/or similar tweaking preferences.

In a sixth scenario, UPcload displays discount specials to a customer based on matching the customer's measurements with an on-line store's discount specials according to size and actual availability in stock.

In a seventh scenario a user downloads an UPcload application to a smartphone, or similar device. The user may scan a barcode of clothing from the UPcload databank, and gets the same shopping experience as online, but on his smartphone! The application deciphers what item of clothing is described by the barcode, and optionally pulls the user's measurements from UPcload's database, matching the user's measurements to the item of clothing.

In yet another scenario, a user is provided with a Body Passport interface. The Body Passport interface is now described from a user's perspective:

When a user has a user profile, the user is optionally requested to provide information/data about himself, and the data is optionally saved in the profile.

After creating the profile, the user can use the profile to be more certain of choosing clothes which fit, optionally providing a better shopping experience.

In order to enhance the user experience beyond services which UPcload provides the user may optionally choose to allow other services, external to the UPcload database, to anonymously see the data in his profile and to offer him services that are based on the data.

The user does not have to do anything more than choose a service which he is interested in, and decide whether he wants the service to access the user's UPcload data once, one use only, or the user may grant the service constant access to the user's data, which will enable the service to always offer the service based on updated data.

If the user wants, the user may terminate the service's access to the user's UPcload data.

The service may be provided as a smartphone application, as notifications to email, on the UPcload website, in a vendor's website, in an UPcload iframe inside the vendor's website.

In yet another scenario, an external interface is now described from an service perspective.

The service utilizes data coming from UPcload about users. The service communicates with UPcload in advance to agree on API.

The service produces a user interface which explains to users what the service provides, where the service can be used and how, and other potential issues related to using the service.

The interface and the service may or may not be located on the UPcload site, and may be located on any platform which enables data transfer.

After a user enters login details for the service, data is optionally transferred from UPcload to the service provider. The service has access to UPcload data and can offer services to the user based on the UPcload data.

A user's UPcload ID may include a payment method, the use of which optionally enables transferring payment to the service vendor.

In case a user wants to terminate use of the service, the user can optionally do so by entering his UPcload account and/or directly at the service website. Once a user terminates a service's access to his UPcload data, the service does not have access to the data anymore, and optionally, no payment will be transferred.

A partial, non-limiting, list of possible services is now described.
a service which utilizes data stored about clothing and/or about the people's measurements and offer visualization services, optionally even 3D visualization, of people wearing clothes. A user optionally sees how he will look wearing an item of clothing. The visualization may be realistic or semi-realistic.
a service which advises a user which clothes to buy. Based on UPcload data, the service advises a user on clothes which the user is interested in—whether or not it is advisable that the user should buy the clothes, and why.
a service which actively suggests clothes which a user should buy. When the user logs into the service, the service displays a list of clothes recommended for the user.
a service which displays which celebrity or any other person in the database is most similar to a user. The service stores body measurements of people, including of body measurements celebrities/person, and compares a user's measurements to other persons' measurements and present the comparison.
a service providing dating services which match a user with a person which looks similar to the user. Optionally, the user enters what kind of appearance he is interested in, and the service matches the user with such people.
a service providing health diagnostics based on user measurement data, and/or optionally provide the user with health suggestions.
a service which enables shops to approach users directly, to offer them discounts, based on knowing the users' measurements and fitting the merchandise offered to the users.
a service which offers life style and/or complementary products. Based on user measurement data, the service optionally categorizes a user, and offers the user complementary services and products which are based on the category of the user.
a service which offers commercials to UPcload users.

Reference is now made to FIG. 8A, which is a simplified illustration of a web page 810 of a first company having an embedded frame 805 of a second company providing measurements according to an example embodiment of the invention.

FIG. 8A depicts the web page 810 advertising a dress, and also depicts an embedded frame 805 of UPcload embedded in the web page 810.

Reference is now made to FIGS. 8B-8H, which are simplified illustrations of various frames referencing sizing information and clothing information according to an example embodiment of the invention.

FIG. 8B depicts a menu frame 815 for providing a user with information.

FIG. 8C depicts a menu frame 820 for providing a user with information about a specific clothing product, and further provides the user with an opportunity to select whether the user prefers clothing to fit tight or loose, and/or to select another size of the product to view.

FIG. 8D depicts a menu frame 825 for providing a user with an image of a person having a similar body type wearing the product which the user is browsing.

FIG. 8E depicts a menu frame 830 for providing a user with information how similar the person depicted in FIG. 8D is to the user's measurements.

FIG. 8F depicts a menu frame 835 for providing a user with information about the product which the user is browsing.

FIG. 8F depicts a menu frame 840 for providing a user with statistical information about the product which the user is browsing.

FIG. 8G depicts a menu frame 845 for providing a user with an opportunity to participate socially in the browsing and possible shopping experience, by optionally uploading comments on the product which the user is browsing, and optionally uploading a picture.

It is expected that during the life of a patent maturing from this application many relevant digital cameras and segmentation methods will be developed and the scope of the terms camera and segmentation method is intended to include all such new technologies a priori.

As used herein the term “about” refers to ±10%.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer program for using a first computer to obtain anthropometric measurements of a person, the computer program implementing a method comprising:
providing instructions to a person to set up conditions for producing a suitable image;
receiving the image from a camera, the image including at least part of the person's body;
analyzing the image;
providing at least one measurement based, at least in part, on the analyzing.

2. The computer program of claim 1 in which the at least one measurement is provided in units of clothing size.

3. The computer program of claim 2 and further comprising accepting input from the person, the input comprising the person's preference for clothing fit.

4. The computer program of claim 2 and further comprising accepting input from the person, the input comprising a clothing size of an article of clothing which the person knows, and an indication of whether the article fits tight, fits well, or fits loose.

5. The computer program of claim 1 in which:
the providing instructions comprises providing instructions from the first computer;
the receiving and the analyzing comprise receiving and analyzing by a second computer; and
the providing at least one measurement comprises providing at the first computer.

6. The computer program of claim 1 in which the measurements are associated with the person and stored for further use.

7. The computer program of claim 1 in which the instructions comprise instructions for the person to hold an object of known dimensions as a dimensional reference in the image.

8. The computer program of claim 7 in which the object is a CD.

9. The computer program of claim 7 in which the object is a circular optical storage medium.

10. The computer program of claim 7 in which the object is a ball.

11. The computer program of claim 1 in which the instructions comprise instructions for the person to stand next to an object with known dimensions, acting as a dimensional reference in the image.

12. The computer program of claim 1 in which the instructions comprise instructions for clothes which the person should wear while the camera is taking the image.

13. The computer program of claim 1 in which the instructions comprise instructions for positioning the camera.

14. The computer program of claim 1 in which the instructions comprise instructions for selecting a background against which the person should be positioned while the camera is taking the image.

15. The computer program of claim 1 in which the instructions include displaying an image stream taken by the camera, and overlaying guide marks on the image stream in order to assist the person to position the camera and to position the person's body so as to produce an image for the analyzing.

16. The computer program of claim 1 in which the analyzing comprises using an image segmentation method to segment an image of the person's body from a background.

17. The computer program of claim 1 in which the receiving an image comprises receiving a plurality of images.

18. The computer program of claim 1 in which the receiving an image comprises receiving a stream of images.

19. The computer program of claim 18 in which:
the providing instructions comprises providing instructions to the person to move the camera, and
the analyzing comprises using an image segmentation method to separate an image of the person from a background against which the person should be positioned while the camera is taking the image, based, at least in part, on analyzing a movement of the person's body relative to the background.

20. The computer program of claim 18 in which:
the providing instructions comprises providing instructions to the person to move relative to a background against which the person is positioned while the camera is taking the image, and
the analyzing comprises using an image segmentation method to separate an image of the person from the background, based, at least in part, on analyzing a movement of the person's body relative to the background.

21. The computer program of claim 1 in which the providing instructions to set up conditions; the receiving an image from the camera; and the analyzing the image, are repeated, and a plurality of measurements is provided.

22. The computer program of claim 1 in which the providing instructions to set up conditions; the receiving an image from the camera; and the analyzing the image, are repeated, and the at least one measurement is based, at least in part, on the analyzing of a plurality of images.

23. The computer program of claim 1 and further comprising storing the at least one measurement in a user profile associated with the person.

24. The computer program of claim 23 and further comprising providing the at least one measurement to an on-line store.

25. A computer on which the computer program of claim 1 is stored.

26. A digital medium on which the computer program of claim 1 is stored.

27. A computerized system for managing a person's anthropometric measurements comprising:
a user interface unit for providing instructions to a person to set up conditions for producing a suitable image and for accepting input from the person;
a camera for sending the person's image to the system; and
a computation unit for computing the person's anthropometric measurements based, at least in part, on the image.

28. The system of claim 27 and further comprising a database for storing the person's profile including at least one of the person's anthropometric measurements.

29. The system of claim 27 and further comprising a communication unit for sending at least one of the person's anthropometric measurements to an on-line store.

30. A method of providing a service of managing a person's anthropometric measurement comprising:
computing a person's anthropometric measurements from images of the person; and
keeping the measurements for use in web shopping.

31. The method claim 30 in which the service is provided by a browser-based program.

32. The method of claim 31 in which the program is configured to be embeddable in a frame comprising a portion of a web page.

33. The method of claim 30 in which the keeping is performed by a cookie on the person's computer.

34. A method for obtaining anthropometric measurements of a person, using a computer and a camera, the method comprising:
(a) the computer providing instructions to a person to pose in a specific pose for a camera to capture the person's image in the pose;
(b) the camera capturing an image of the person in the pose;
repeating (a) and (b), thereby instructing the person to pose in a set of poses, and capturing a set of images;
(c) analyzing the set of images; and
(d) providing anthropometric measurements based, at least in part, on the analyzing.

35. The method of claim 34, in which the person is asked to provide personal, bode-related information, and the set of poses is selected based on the information.

36. The method of claim 34 and further comprising:
analyzing an image following the capturing of at least one image; and
selecting additional poses based on analyzing the at least one image.

37. The method of claim 36 in which the analysis detects a fat person, and the additional poses are selected from poses considered especially useful for measuring fat persons.

38. The method of claim 36 in which the analysis detects a slim person, and the additional poses are selected from poses considered especially useful for measuring slim persons.

39. The method of claim 36 in which the analysis detects a missing measurement, and the additional poses are selected from poses considered especially useful for analyzing the missing measurement.

40. The method of claim 36 in which the analysis does not identify a key body location, and the additional poses are selected from poses considered especially useful for identifying the key body location.

41. The method of claim 34 and further comprising:
if an anthropometric measurement cannot be computed based on analyzing the set of images, then instructing the person to pose in at least one additional pose selected to enable computing the measurement.

42. The method of claim 35, in which the personal information includes gender.

43. The method of claim 35, in which the personal information includes body type.

44. The method of claim 35, in which the personal information includes selecting a value from the group short, average, tall, extra tall, and extra short.

45. The method of claim 35, in which the personal information includes selecting a value from the group slim, average, fat, extra fat.

46. The method of claim 34 in which at least one pose is a pose in which the person stands facing the camera, with arms away from the body, and the anthropometric measurements include an arm length expressed in terms of sleeve length.

47. The method of claim 46 in which if a sleeve length measurement cannot be computed based on analyzing the set of images, then instructing the person to pose in at least one additional pose in which the person stands facing the camera, with arms further away from the body than in an already captured pose.

48. The method of claim 34 in which at least one pose is a pose in which the person stands facing the camera, with feet apart, and the anthropometric measurements include a trouser length expressed in terms of inseam length.

49. The method of claim 48 in which if an inseam length measurement cannot be computed based on analyzing the set of images, then instructing the person to pose in at least one additional pose in which the person stands facing the camera, with feet further apart than in an already captured pose.

50. The method of claim 34 in which at least one pose is a pose in which the person stands facing the camera, and at least one pose is a pose in which the person stands with a profile toward the camera, and the anthropometric measurements include a waist circumference.

51. The method of claim 34 in which at least one pose is a pose in which the person stands facing the camera, and at least one pose is a pose in which the person stands with a profile toward the camera, and the anthropometric measurements include a neck circumference.
